(19) United States
(12) Patent Application Publication
(10) Pub. No.: US 2018/0146361 A1
(43) Pub. Date: May 24, 2018

(54) ENHANCED LOCAL DATA SERVICES

(71) Applicant: GLOBETOUCH, INC., Oakland, CA (US)

(72) Inventor: John Yue JIANG, Oakland, CA (US)

(21) Appl. No.: 15/818,321

(22) Filed: Nov. 20, 2017

Related U.S. Application Data
(60) Provisional application No. 62/424,973, filed on Nov. 21, 2016.

(51) Int. Cl. H04W 8/02; H04W 4/02; H04W 8/18; H04W 12/04

(52) U.S. Cl. CPC H04W 8/02; H04W 12/04; H04W 8/183; H04W 4/02

(57) ABSTRACT

The present invention is directed towards a method and system for facilitating local data services for the users. The method involves detecting a location update message of a user at a gateway, where the gateway is part of a communication exchange system having an ecosystem of one or more HPMN and VPMN operators. The gateway further enables one or more of a real profile and a virtual profile in user's device to enable local data services for the user. The real and virtual profile are from a partner operator within the ecosystem of the HPMN and VPMN operators. The user's device has one or more of a soft-SIM, normal SIM, an embedded SIM, an interface, and a SIM applet.

### RELATED APPLICATIONS

This application claims priority from U.S. Provisional Patent Application 62/424,973 entitled “Integrated Cloudsim And Sim-Mux Approach For Dynamic Cellular Profile Change To Cellular Devices,” filed on Nov. 21, 2016. The aforementioned patent application is incorporated herein by reference in its entirety.

### FIELD OF THE INVENTION

The present invention generally relates to mobile communications. More specifically, the invention relates to enabling local data services while roaming.

### BACKGROUND OF THE INVENTION

Roaming traffic contributes a significant percentage of an operator's revenue and even a better percentage of the operator's margin. With increasing competition and regulatory control, operators are being more pressured to increase their roaming revenue. As the global mobile roaming market business model is evolving, the industry understands the strategic importance of roaming to operator's revenues and profit margins and is adapting various newly proposed regulations. The operators understand that they must develop strategies for driving the number of roamers and roaming usage, while lowering tariff rates. Mostly, the roaming revenue is contributed by voice calls based revenue and less revenue contribution is due to data services. Around 70% of global mobile data users do not use data services when on roaming. Hence, data roaming is currently underutilized by a factor of 25 times despite significant uptake with much reduced retail pricing and 10% increase of data roamers.

This situation would is exacerbated with the increasing adoption of smartphone and 4G technologies. Data roaming is still the primary source of customer complaints and comprehension as it is difficult to count volume of data usage on smartphone applications given the variety of the background running usage; while voice and messaging can be easily controlled and understood by the customers via CDRs.

Gone are the days when data usage used to be a luxury option. Now, it is a necessity of everyday use of mobile phone. In fact, it is the essence of keeping in touch these days given the popular adoption of social media platforms. It is also an increasingly important source of exchanging valuable information and conducting e-commerce.

In accordance with the foregoing, there is a need in the art of a system, a method, for creating a solution that gives an operator the ways to leverage the ecosystem of partnering operators to enable a user use data services while roaming, at competitive rates, with the aim of simplifying user's experience and maximizing roaming revenue for participating operators.

### SUMMARY

The present invention is directed towards a method for facilitating local data services for the users. The method involves detecting a location update message of a user at a gateway, where the gateway is part of a communication exchange system having an ecosystem of one or more HPMN and VPMN operators. The gateway further enables one or more of a real profile and a virtual profile in user's device, to enable local data services for the user. This real and virtual profile is from a partner operator within the ecosystem of the HPMN and VPMN operators. The user's device has one or more of a soft-SIM, normal SIM, an embedded SIM, an interface, and a SIM applet.

The present invention is also directed towards a method for enabling local data services for the user by enabling of the virtual profile of the partner operator by adding an identifier to APN of the user to enable the local data services when roaming in the VPMN. The local data services are enabled via the interface that maintains a bi-directional connection with the gateway and the interface in the user's device.

The present invention is also directed towards a method for enabling the real profile of the partner operator by allocating a dynamic IMSI with either a partial IMSI profile or a full IMSI profile based on the user's device. The full profile that has security key information of a HPMN or the VPMN. The method further includes switching from the user's device's IMSI profile to one of a HPMN IMSI profile or local IMSI profile of the partner operator. The partner operator within the ecosystem is selected by a cloudSIM hub that acts as the gateway, depending on one or more of location of the user's device, and quality and regulatory requirements of roaming service associated with the user's device.

The present invention is directed toward a communication exchange system where an ecosystem of one or more HPMN and VPMN operators that are connected to a gateway/exchange that facilitates local data services for users. The system includes a gateway that detects a location update message of a user and enables one or more of a real profile and a virtual profile from a partner operator, to facilitate local data services in the user's device. The user's device has one or more of a soft-SIM, normal SIM, an embedded SIM, an interface, and a SIM applet.

### BRIEF DESCRIPTION OF DRAWINGS

In the drawings, the same or similar reference numbers identify similar elements or acts.

FIG. 1 illustrates a system for implementing communication exchange for local data service, in accordance with an embodiment of the present invention;

FIG. 2 represents a flowchart for implementing communication exchange for local data service, in accordance with an embodiment of the present invention;

FIG. 3 represents a flow diagram for implementing the local data service using CloudSIM approach, in accordance with an embodiment of the present invention; and

FIG. 4 represents a flow diagram for implementing the local data services, using DataX approach, in accordance with an embodiment of the present invention.

### DETAILED DESCRIPTION

In the following description, for purposes of explanation, specific numbers, materials and configurations are set forth in order to provide a thorough understanding of the present invention. It will be apparent, however, to one having ordinary skill in the art that the present invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the present invention. The appearance of the phrase “in an embodiment”, in various places in the specification, does not necessarily refer to the same embodiment.

The present invention incorporates certain references from two applications filed previously by the inventor of this present application John Jiang. The two previous applications that are referred hereinafter in their entirety are:
application Ser. No. 15/085,689, titled “Enhanced Cloud SIM”, filed on 30Mar. 2016. This application is hereinafter interchangeably referred as “CloudSIM”
application Ser. No. 15/461,143, titled “Communication Exchange for Local Data Services”, filed on 16 Mar. 2017. This application is hereinafter interchangeably referred as “Data X”

The present invention provides a system and a method for facilitating local data services for a user of a Home Public Mobile Network (HPMN) roaming in a Visited Public Mobile Network (VPMN). In accordance with various embodiments, the present invention provides a method and system providing the user a facility to use data services even while roaming but charged at local rates.

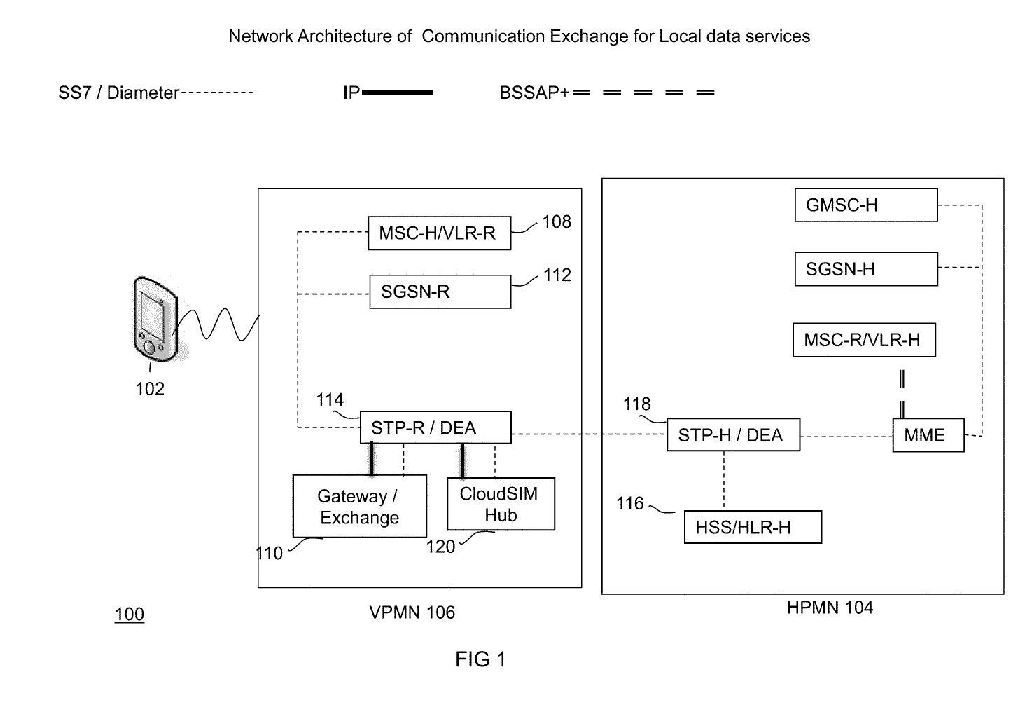

FIG. 1 illustrates a system 100 for facilitating the local data service for roaming users, in accordance with an embodiment of the present invention. A user 102 of HPMN 104 (from home country) is roaming in a VPMN 106 (from visiting country). For sake of representation only two operators (HPMN and VPMN) are shown, however, in various embodiments of the present invention, exchange 110 works with an ecosystem that has multiple operators (HPMNs and VPMNs), who would like their subscribers to use this facility of local data services.

The user 102 is connected to a VPMN VLR 108, when it is roaming outside HPMN 102. The system 100 includes a gateway 110, hereinafter, interchangeably referred to as communication exchange 110 or exchange 110 that facilitates local data services for user 102 while in VPMN 106, in accordance with various embodiments of the present invention. The gateway 110 detects a location update message from user 102, and inserts either a real profile or a virtual profile from a partner operator. This partner operator is part of the ecosystem. In accordance with various embodiments of the present invention, this partner operator is VPMN 106. In other embodiments this partner operator could be any other operator that either has a roaming relationship with HPMN 102 or no roaming relationship with HPMN 102.

In one embodiment of the invention, VPMN VLR 108 is connected with an SGSN-R 112, which is further connected with STP-R/DEA 114, via SS7 protocol. The exchange 110 is connected with STP-R/DEA 114 via IP in monitoring mode. User profile data corresponding to user 102 is stored in HPMN HLR-H 116. The signaling corresponding to user 102 is routed using STP-H 118. The signaling between HPMN 104 and VPMN 106 is carried using SS7 signaling architecture. The signals exchanged between HPMN 104 and VPMN 106 are MAP based signals.

In accordance with various embodiments of the application, the ecosystem also includes a CloudSIM Hub 120 that enables the local data services for the user 102 in case the real profile of operator is used. The accordance with another embodiment of the present invention, the Gateway 110 enables the local data service for the user 102 in case the virtual profile of operator is used.

In accordance with various embodiments of the present invention, the enablement of the real profile or the virtual profile of the operator is done based on one or more of location of the user, class of the user, quality of service from the partner operator, coverage of the partner operator, tariff charged by the partner operator, and device of the user.

The user 102 uses a smartphone device that either a soft-SIM, or normal SIM, or an embedded SIM, or an interface, or a SIM applet. The interface can update itself or even provide end to end security between interface and gateway 110, or act as a firewall protection for the user's device. The interface could be a software application that helps in maintaining a bi-directional connection with gateway 110 to exchange information related to the roaming services, and a bi-directional connection with user 102 via his/her mobile devices' user interface. The interface for user could be either a mobile application, a web interface, a desktop interface, an IoT device, a connected car interface, or even a smart watch interface.

For sake of representation, system 100 represents network elements from both LTE and GSM networks. HPMN 104 including HSS/HLR-H 116 connects via a STP-H/DEA 118 to an MME, which is further connected to an MSC-R/VLR-H in HPMN 104 via BSSAP+ protocol. These network elements communicate with each other over a Signaling System 7 (SS7) link.

It will also be apparent to a person skilled in the art that HPMN 104 and VPMN 108 may also include various other network components (not shown in FIG. 1), depending on the architecture under consideration. It will also be apparent to a person skilled in the art that various components of HPMN 104 communicate with VPMN 106 using various signaling techniques including, but not limited to, SS7, SIP, IP, ISUP etc.

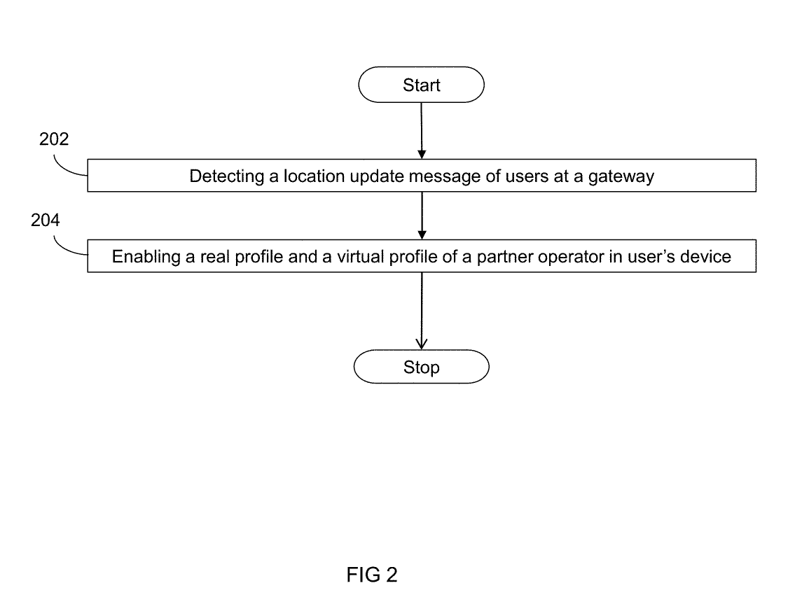

FIG. 2 represents a flowchart for implementing the communication exchange for local data service, in accordance with an embodiment of the present invention. At step 202, gateway 110 receives a location update message of user 102. Thereafter, at step 204, the gateway 110 enables either a real profile or a virtual profile of a partner operator to enable local data service for the user 102. The partner operator is VPMN 106. The decision for selecting either real or virtual profile depends if the user 102 device a soft-SIM, normal SIM, an embedded SIM, or an interface application.

In accordance with an embodiment of the present invention, if the real profile is enabled, then the profile is downloaded to the user 102's device's SIM over the air and used by the device for registration. In this case the cloudSIM hub 120, allocates a dynamic IMSI with either a partial IMSI profile or a full IMSI profile based on the user's device. The full profile has security key information of a HPMN or the VPMN. Furthermore, the CloudSIM hub 120 switches from the user's device's IMSI profile to one of a HPMN IMSI profile or local IMSI profile of the partner operator. The partner operator (e.g. VPMN 106) within the ecosystem is selected by a cloudSIM hub 120 depending on either location of the user's device, and quality and regulatory requirements of roaming service associated with the user's device.

In accordance with another embodiment of the present invention, the operator 106 is selected based on various criteria like wholesale tariff agreed in visited country, type of subscriber, devices being services, pre-paid or postpaid plan, full service or data service only, or cost or QoS ranking of network in visited country.

In accordance with various other embodiments of the present invention, cloudSIM hub 120 uses a SIM STK in a standard SIM card along with OTA function to handle dynamic IMSI allocation. In another embodiment of the present invention, cloudSIM hub 120 uses a DIA to perform the dynamic IMSI allocation.

In accordance with an embodiment of the present invention, cloudSIM hub 120 dynamically allocates IMSI in either a push mode or a pull mode. For example, the pull mode is implemented in case user's devices 102 do support USSD, where USSD is used to notify cloudSIM DIA platform about current country and network of the user's device.

In push mode, when cloudSIM DIA platform gets location notification from a roaming probe instead of cloudSIM STK applet and starts dynamic IMSI allocation workflow itself. Hereinafter, cloudSIM STK applet is interchangeably referred to as applet or cloudSIM applet. The same workflow is applied for user's devices that do not implement STK Provide Location Information (PLI) command correctly to get the details of the current network (MCC—Mobile Country Code and MNC—Mobile Network Code) where the user device is latched on. Likewise, for user's devices 102 which don't support STK Refresh command, a different workflow is followed to inform the user's device 102 about IMSI switch by issuing a SIM STK display text message to inform the user to switch off/on the user's device. If the device does not support the proactive command Refresh, the applet can issue a Display Text command to ask the user to restart the device. The display text can be deactivated for devices without display e.g. some M2M devices.

In general the cloudSIM applet supports pull based approach i.e. once the user device is latched on to any network in Visited Country (either using Home IMSI or using Global Roaming IMSI) and the applet doesn't get a dynamic IMSI applicable for that location, the applet then sends USSD notification to cloudSIM DIA platform with the current location information and the DIA platform via OTA downloads a suitable dynamic IMSI for the current location. In the applet of the present invention, it is able to disable the notification from the applet to DIA platform even if the applet gets a notification from the device about the new roaming location of the subscriber). The applet just lets the device remain latched on using current IMSI and waits for any OTA SMS from the DIA server with a new dynamic IMSI for the current location. This case is applicable for certain client operators who prefer alternative source of location trigger e.g. roaming probes due to lack of USSD support in devices or network. This is referred to as push mode operation of DIA workflow in accordance with various embodiments of the present invention.

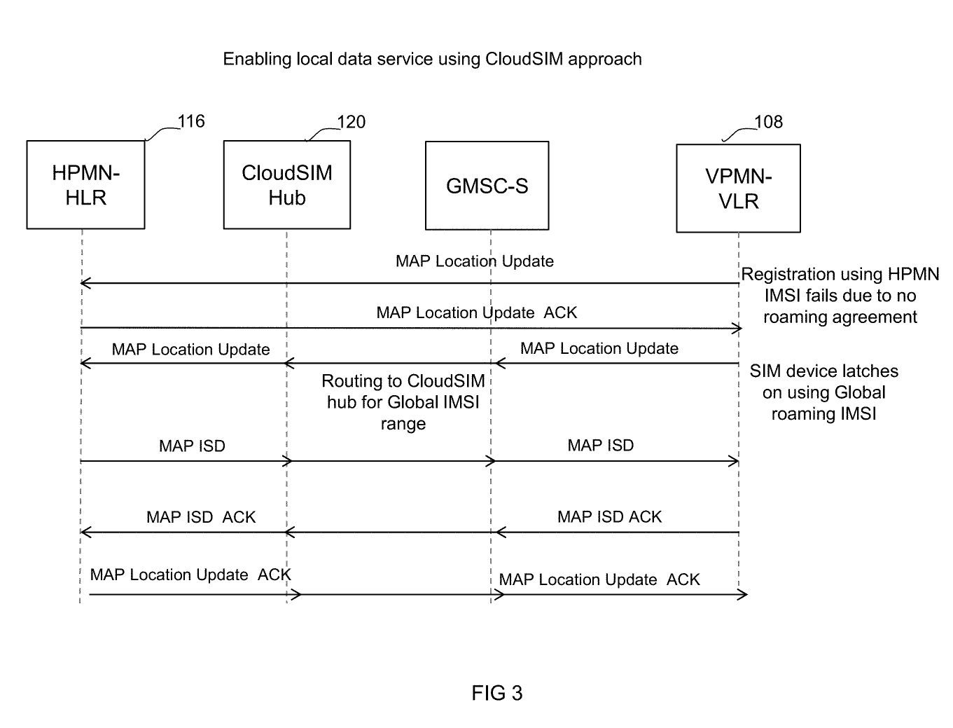

FIG. 3 represents a typical call flow for enabling local data service for the user 102 using global IMSI that is dynamically allocated by cloudSIM hub 120, in accordance with an embodiment of the present invention. As seen in the call, the initial registration attempt from VPMN 106 fails as there is no roaming agreement. The cloudSIM hub monitors the location update message, as a global roaming IMSI provisioned from cloudSIM is routed through cloudSIM platform. In other words, cloudSIM hub monitors the network registration of the current IMSI in user's device to know the current roaming country and network of the user device. The cloudSIM hub 120 then allocates an IMSI suitable for current VPMN 106 using DIA business rule engine and downloads either full IMSI profile or partial IMSI profile from HPMN 104 or VPMN 106 using standard SIM OTA technology. Then the user device 102's registration is initiated at VPMN 106 using the downloaded IMSI profile.

The global roaming IMSI is an IMSI of any other network (e.g. provided by any other MNO or any roaming hub service provider) which is used for roaming in case HPMN doesn't have roaming agreement in any destination country. The global roaming IMSI is not mandatory and may or may not be present depending on the client. In case the Home Network IMSI cannot register to any network in the current visiting country of subscriber (the location status is in Limited Service) as there is no bilateral roaming agreement (or due to any other reason), the applet should detect the same and check if there is a Global Roaming IMSI present in the IMSI Slot. This IMSI is provisioned in SIM card during personalization but should be downloadable using OTA later to change the original global roaming IMSI. There can be multiple global roaming IMSI (with each global roaming IMSI applicable for a different set of countries) in the SIM card of the subscriber.

If there is a global roaming IMSI present, the applet makes that IMSI as active IMSI and force the user device to latch on using that global roaming IMSI. The configurable time period (e.g. 6 minutes) before the switching process to global roaming IMSI starts. This ensures that if home IMSI cannot latch on due to coverage issue of roaming partner network, it gets sufficient time to get back to coverage before the global roaming IMSI takes over.

If there are multiple global roaming IMSIs available in the IMSI slot, then each global roaming IMSI also contains the list of MCC-MNC where that global roaming IMSI will work. The applet refers to that list to select the right global roaming IMSI. However, it should be also possible to keep on the global roaming IMSIs as default global roaming IMSIs by not configuring a list of MCC-MNC so that if the current MCC-MNC doesn't appear with other global roaming IMSI, the applet can select this global roaming IMSI as default. The applet latches on to a global roaming IMSI if it doesn't get the location information of current location of subscriber. If the user device cannot latch on to global roaming IMSI, the applet should wait for a configurable time period (e.g. 6 minutes) before start attempting registration using home IMSI again. In case no global roaming IMSI is available, the device should stay in limited service mode till next power on cycle.

In accordance with various embodiments of the present invention, the dynamic IMSI allocation is done using either a local IMSI, or a permanent roaming IMSI, or a global roaming IMSI or a temporary roaming IMSI. The user device's 102 IMSI is based on location of user device 102, or class of the subscriber. The subscriber's IMSI is changed via a configuration file that can be changed by OTA communication. Alternatively, the subscriber's IMSI is changed by SIM STK application that communicates with network application via USSD, or SMS or any other bearer. The cloudSIM hub 120 stores IMSI and other subscription data in applet buffer via STK. Alternatively, cloudSIM hub 120 selects default IMSI from a sequence of IMSIs in preference order or random order, until one IMSI is successfully registered VPMN 106.

In accordance with another embodiment of the present invention, cloudSIM hub 120 converts one or more signaling parameters of signaling associated with the Home operator's IMSI to one or more signaling parameters of the signaling associated with user device's IMSI (from Hub Operator). The signaling parameters can be either MAP signaling, call signaling, subscriber's MSISDN, CAMEL/SIP/TCAP transaction, data sessions and data traffic. The hub operator is either an MVNO, an MNO, having its own set of IMSIs. The cloud SIM hub could be located either on-net the hub operator or off-net the hub operator.

CloudSIM hub 120 when allocating dynamically the IMSI with partial or full profile has various use case scenarios. In accordance with an embodiment of the present invention, when dynamic IMSI full profile (including security key, APN etc.) is based on VPMN 106, then cloudSIM hub 120 maintains billing and provisioning interface with the VPMN 106, and all signaling and data routing is done locally through VPMN 106.

In case dynamic IMSI partial profile has only IMSI based on the VPMN, then cloudSIM hub 118 handles signaling and data routing within cloudSIM ecosystem to configure the mapping of IMSI to another HPMN IMSI and redirect data to corresponding data gateway of HPMN 104. It will be apparent to a person skilled in the art that different dynamic IMSI profile might be routed or mapped to different HPMNs thru cloudSIM ecosystem.

In yet another embodiment of the present invention, when dynamic IMSI profile is partial with IMSI and Ki from a local VPMN 106 but the APN points to cloudSIM hub 120, then signaling is with VPMN 106 directly but data session is routed thru cloudSIM ecosystem to a mapped IMSI to an HPMN gateway. This allows authentication to be done at VPMN 106 but data service is at another HPMN.

In accordance with another embodiment of the present invention, the dynamic IMSI profile is partial with IMSI based on local VPMN 106 but Ki points to one home IMSI of one HPMN, and the APN points to cloudSIM hub 120 and the data service goes to another home network HPMN. In this case, the signaling routing goes thru cloudSIM hub 120 which maps the IMSI to IMSI of HPMN 104. But when data session goes through cloudSIM hub 120, the data service goes to the data gateways (and associated BSS/OCS/PCRF) of another home network. This allows authentication to be done at one HPMN but data service is at another HPMN.

The above four scenarios in accordance with various embodiments of the present invention, are explained further with help of below examples from M2M connected car ecosystem's perspective.

In an exemplary case, if the user device is located in US, based on the cellular registration of the device 102 on the current SIM profile, a roaming with best rate (e.g. Rogers) profile or a local profile (e.g. ATT) can be loaded to the SIM provisioned by cloudSIM hub 120 over the air via a cloud business logic. For some device use cases due to regulation, e.g. car sold to India, a local operator (e.g. Airtel) profile will be dynamically downloaded to the car over the air.

In an exemplary case, a car is sold in India and AirTel IMSI is provisioned as active IMSI. The subscriber profile (IMSI, Ki etc) will be provisioned in AirTel HLR. The APN for data services in the device will also from AirTel. So, all the services (Registration, data services) will be provided by AirTel India network. The CloudSIM Home Network (of Globetouch in Sweden) will only have provisioning and billing interfaces implemented with AirTel India brovisioning and billing systems to have necessary controls on the processes and have visibility of overall service. This is needed as GlobeTouch is primary connectivity provider for the connected car manufacturer (e.g. Honda). This can be another MNO network (e.g. Vodafone UK) instead of GlobeTouch if that MNO is the primary connectivity provider for the connected car manufacturer (with GlobeTouch just the technology provider).

In another use case, a car is sold in India and AirTel IMSI is provisioned as active IMSI. The difference from above scenario 1 is that the subscriber profile will not be provisioned in AirTel HLR. The subscriber profile will be provisioned either in Globetouch Sweden Network or any other MNO network (e.g. Vodafone UK) which is the Home Network for the car. The subscriber profile will have HPMN IMSI in HLR (GlobeTouch IMSI if GlobeTouch HLR being used or another MNO IMSI e.g. VF UK IMSI if the same network is the Home Network). The APN for data services in the device will also from HPMN (GlobeTouch or VF UK as applicable). So, all the signaling and data traffic will be routed via cloudSIM Hub which will do the IMSI translation (e.g. from AirTel IMSI to GlobeTouch IMSI or from AirTel IMSI to Vodafone UK IMSI) and route the signaling/data traffic to right HPMN. This scenario provides full control of the services by HPMN which is the primary connectivity provider for the connected car manufacturer (e.g. Honda).

In yet another use case, the car is sold in India and AirTel IMSI is provisioned as active IMSI. The subscriber profile (IMSI, Ki etc) will be provisioned in AirTel HLR. The difference from first scenario is that the APN for data services in the device is also from GlobeTouch or another Home MNO (e.g. Vodafone UK) as applicable instead of AirTel APN. As the subscriber profile will be in AirTel HLR, all the signaling (basically for network authentication and registration) is routed directly to AirTel HLR. However, as the APN is of GlobeTouch (or VF UK), the data traffic will come to cloudSIM hub 120, which does the IMSI translation (e.g. from AirTel IMSI to GlobeTouch IMSI or from AirTel IMSI to Vodafone UK IMSI) and routes the data traffic to GlobeTouch (or VF UK) GGSN. This scenario allows to have control of the data traffic by HPMN which is the primary connectivity provider for the connected car manufacturer (e.g. Honda), where the local IMSI (AirTel in this case) must be used for some reason (e.g. regulation in some countries to always use a local profile for cars sold in India).

In yet another use case, a car is sold in India and AirTel IMSI is provisioned as active IMSI. However, like in second scenario, the subscriber profile is not provisioned in AirTel HLR. The subscriber profile is provisioned in other MNO network (e.g. Vodafone UK) which is the Home Network for the car. The subscriber profile will have HPMN IMSI in HLR (e.g. VF UK IMSI). However, the difference from the second use case is that the APN is not of HPMN (VF UK) but it will be for another network (in most cases in will be GlobeTouch but can be any other MNO APN also). As the subscriber profile will be in VF UK HLR, all the signaling (basically for network authentication and registration) will be routed to cloudSIM Hub, which will do the IMSI translation (e.g. from AirTel IMSI to Vodafone UK IMSI) and route the data traffic to Vodafone UK HLR. However, as the APN is of GlobeTouch, the data traffic will come to cloudSIM hub 120 which will do the IMSI translation (e.g. from AirTel IMSI to Vodafone UK IMSI) and route the data traffic to GlobeTouch GGSN with VF UK IMSI. In case of another Home MNO, whose GGSN/BSS may not support provisioning of another MNO IMSI (VF UK IMSI in this case), the cloudSIM hub 120 translates AirTel IMSI to that network Home IMSI (e.g. AirTel IMSI to AT&T USA IMSI if AT&T is the home network in this example). This scenario allows getting better data roaming rates leveraging some other MNO/servicing provider's data services which controlling authentication/network registration by home network who is the primary connectivity provider for the connected car manufacturer (e.g. Honda).

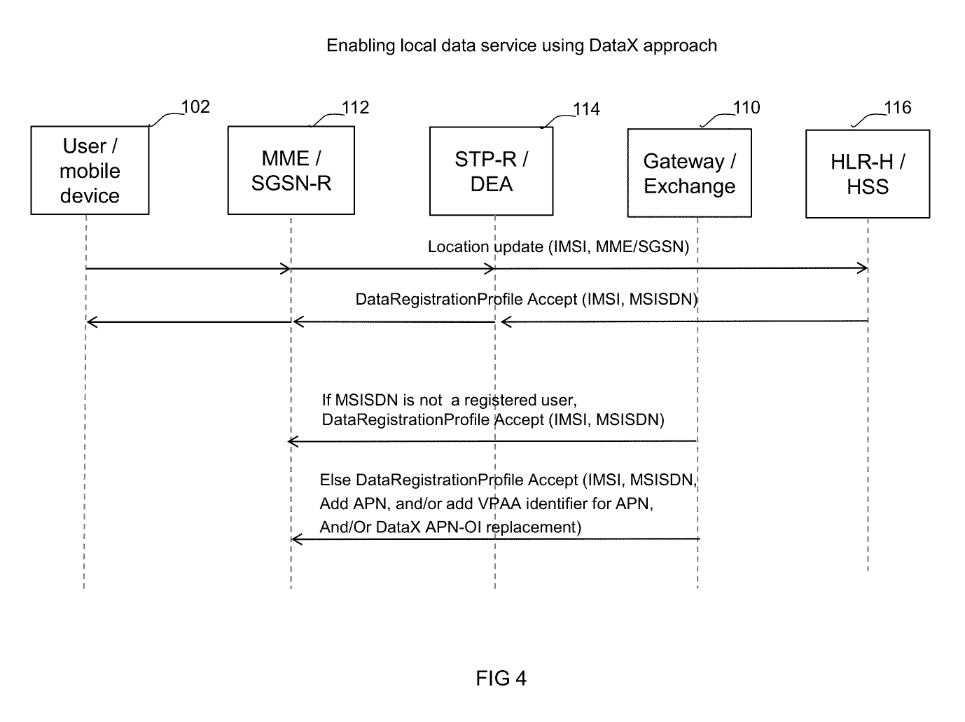

FIG. 4 represents a flow diagram for implementing the local data services, using DataX approach when the gateway 110 enables the virtual profile of partner operator (such as VPMN 106), in accordance with an embodiment of the present invention. In this case VPMN 106 has gateway/exchange 110 functioning in monitoring mode to monitor incoming roaming users' data registration at SGSN-R 112. The gateway 1110 dynamically either adds VPAA identifier to APN profile to user's 102 profile at SGSN-R 112 or modifies APN to point to VPMN 106, if user 102's MSISDN is registered for local data services. Subsequently, VPMN 106 updates its DNS to LBO APN to facilitate an incoming data session request on LBO APN to be resolved to local GGSN/PGW. In case the user 102's MSISDN is not registered, then exchange doesn't make any change in its APN.

The following embodiments of the present invention explain the implementation of the local data service in accordance with DataX approach of the previous patent application.

In accordance with various embodiments of the present invention, the exchange 110 is a B2B2C cloud-based electronic trading service that is built on an clearing exchange with an ecosystem of mobile operators (considered as merchants) that allows users such as user 102 through a software front end interface (without requiring them to change their mobile device and/or SIM) to sell and buy a local rate data package for use of a roaming or local device in a mobile operator of the ecosystem. In addition to cross operator trading between users of different networks, the users of a joining operator can even buy and sell local rate data packages in the same network. This electronic market place simplifies the user experience by enabling a pure smartphone (such as, but not limited to iOS based devices, Android based devices) application interface for the trading service.

In accordance with various embodiments of the present invention, the exchange 110 provides a seamless experience to user 102. A roaming user or a local user with a smartphone (as defined above) with an unchanged HPMN 104's SIM using an application downloaded from an application store registers an account with the trading service, provided by exchange 110. Now, through this application, the user 102 can buy a local rate data package offered by a local mobile operator with a stored wallet or a payment method. In accordance with several embodiments of the present invention, the interface enables payments related to sale or purchase of data packages, using at least one of mobile wallet, PayPal, Credit Cards, Debit Card, wire transfers, NFC payments, WePay, Alipay, Pay™, and online payment systems. Once the user 102 has bought a data package, the data package can be activated on a scheduled time, on registration automatically or on demand manually. The user 102 may also manually select the mobile operator (via the application the application or via the user's mobile interface) or the user 102's phone is automatically steered to the desired mobile operator.

An enterprise service administrator (local or international) using the software interface (i.e., the application on user's mobile or a web interface or just a desktop client) registers an account with the trading service and can then buy an individual or group local rate data package on the trading platform for an individual or group of mobile devices (such as a company's employee group, M2M and Internet Of Things) the enterprise manages. Once a device is part of a bought package, the device's local usage can be activated on a scheduled time, on registration automatically or on demand remotely over the air. The device may also be configured for the selected mobile operator remotely over the air or be automatically steered to the mobile operator. Individual device's usage and monetary spending can also be controlled by the administrator.

User 102 with a smartphone with an unchanged home operator SIM using an application on his smartphone registers an account with the trading service. Now through the application, user 102 can sell a portion of his unused local rate data package bought on the trading platform to another roaming traveler or a local user. The application informs the user how much data used so far and how much data is unused on its current data plan. Once the portion is sold, the user would be credited with the money in its stored wallet.

A mobile operator using the interface registers an account with the communication exchange 100/trading service, and can price and sell a local rate data package for one or more devices on the trading platform. Once the portion of package is sold, the operator account would be credited with the money in its stored wallet. The buyer could be a local user or a roaming user or local enterprise or international enterprise.

An enterprise service administrator using the interface registers an account with trading service 110 and can sell a portion of the enterprise's unused local rate data package bought on the trading platform. The software interface informs the administrator on usage of the data. Once the portion of data package is sold, the enterprise account would be credited with the money in its stored wallet. The buyer could be a local user or a roaming user or an enterprise.

It will be apparent to a person skilled in the art that the trading service 110 of local rate data plan can also be used by locals within the same operator or roaming devices between operators of national roaming and international roaming. Moreover, an operator merchant normally only sells data packages although there is no system restriction for the merchant to buy data packages as an enterprise too. However, non-operator merchant seller is restricted to sell only data packages that are bought via the trading service.

In accordance with various embodiments of the present invention, user 102 can buy the local data services plan with or without an Internet connection. In first embodiment, without an Internet connection, as long as there is a merchant or operator in the country for user 102, the user can go through the setting of a local data connection path for only accessing restricted sites, e.g. buying a plan or even activating plan. This local data connection would be free to the user.

However, when user 102 registers at the operator (e.g. VPMN 106), gateway 110 defines an APN or adds a VPAA or APN-OI as defined in profile modification approaches (either APN change or no APN change approach) mentioned earlier. Only then user 102 is allowed free internet access. Even though user 102 has not bought a plan, the profile modification will still proceed as long as the user's MSISDN is registered with the gateway 110 for local data service.

In some embodiments of the present invention, all inbound roamers profiles are modified as in such a way, so as to eliminate the need for external IP interface between merchant operators and the gateway 110 for dynamic profile modification.

In accordance with another embodiment of the present invention, when user 102 tries to buy a plan via the OTT, if there is no Internet connection at the country, the OTT guides user 102 in setting a local data connection, should there be an operator in the current country. This involves setting an APN and selecting the operator. In fact there can be an explicit user experience in the OTT to recommend or having an option to set up a free local data connection.

In accordance with an embodiment of the present invention, activating the local services plan in a country also requires an Internet connection, and as there might not be a Wifi connection or data roaming charge is undesirable, the interface (or the local data service application) still allow user 102 to activate the local data services plan or access the service without incurring charges by setting up a free local data connection.

In order to setup a free local data connection, user 102 needs to select an operator network from the ecosystem, and sets the right APN by following the activation steps. In an android setup, it can be done offline by selecting or setting the APN of communication exchange 110. In iOS, the APN need be configured via a profile. To do offline mode (assuming there is no Internet connection yet) for iOS, user 102 needs to click the mobileconfig file in the welcome email attachment sent to user 102 at the time of registering to the local data service. The mobileconfig file can be signed by a trusted root certificate by the iOS so it can still be installed offline. Once the profile is installed, the user can have an APN that allows data services.

Since the local data services plan is cached, a user can buy the plan later even when there is no connection. Since there is no verification of payment, the plan bought is only tentatively available. This can be concluded whenever there is a connection available. This embodiment can be particularly useful, if there is no WiFi connection and no local merchant available at the current country.

In accordance with various embodiments of the present invention, a member operator of the ecosystem plays two key roles, one as a visiting operator for inbound roamers and another as a home operator for its outbound roamers. As a visiting operator, the member operator can configure to offer its local data plans to selected home operators (which don't have to be a member of the ecosystem) who have a data roaming relationship with the member operator. In accordance with an embodiment of the present invention, the selection of operator is based on all operators, subset of individual operators (e.g. ATT, China Mobile, or groups of operators (e.g. Vodafone group, Telefonica group etc), or alliances (e.g. Connexus, Bridge etc) or based on selections of previous choices who grant explicitly or implicitly the member operator for the local data service. The home operator (HPMN 104) has a subscriber profile for its outbound roamers with local breakout APN.

In another embodiment of the present invention, as home operator HPMN 104 (as a member operator of the ecosystem) configures explicitly to grant local data services to selected visitor operators (which aren't a member of the ecosystem) who have a data roaming relationship with HPMN 104. The selection can be based on all operators, subset of individual operators (e.g. ATT, China Mobile, or groups of operators (e.g. Vodafone group, Telefonica group etc), or alliances (e.g. Connexus, Bridge etc).

Additionally in this embodiment, HPMN 104, also adds an explicit local breakout APN for the gateway 110 or similar local breakout service. In this case, the dynamic profile gateway 110 would not require to need insert a local breakout APN. The OTT app's APN profile for user 102 would be dynamic based on the HPMN 104's local breakout APN. The HPMN 104 can also choose to add a revenue share charge requirement for such an APN use by VPMN 106. The revenue charge can be bilateral but best to be defined as a standard rate (e.g. 20% of retail data plan offered by the visiting member operator to the inbound roamer).

In accordance with an embodiment of the present invention, steering of roamers to VPMN 106, HPMN 104 provides APN in their users' profiles (and as a default APN for some SIMs, e.g. local data travel SIMs) to ease APN selection/configuration. Also HPMN 104 helps set up merchant ecosystem without the need to deploy local nodes or configure DNS in merchant networks, as the APN is resolved by HPMN 104 DNS. The welcome email or the APN profile will be dynamically created based on home operator of subscriber's registered number.

In accordance with other embodiments of the present invention, for some member operators based on their SGSN/SGW capabilities, the member operator configures their SGSN with the following rule:
If subscriber mobile's access APN is not defined in subscriber profile at the SGSN or the profile contains a wildcard APN, and the APN is a supported local breakout APN by the member operator, then the SGSN/SGW accepts the mobile's access APN and the APN DNS can point to the local break out gateway 110 of the cloud infrastructure.

With this approach, there is no need to deploy dynamic profile gateway (i.e., gateway 110) at such a member operator. This approach is particularly useful for operators with small SGSN footprint, as there aren't many configurations required for SGSNs. This approach is also useful for member operator to offer on-demand prepaid local data service via the application (i.e., interface) to its own subscribers as long as the subscribers is using LBO/DataX. For example, user 102 can on demand buy a daily plan, a weekly plan (without or running out of a recurring subscription plan). In this case, member operator puts this APN as a non-default or default APN of the subscriber profiles in HLR/HSS 118.

It would be apparent to a person skilled in the art that if a user or his subscriber is not subscribed to DataX services then gateway 110 can block the user from using local data services. For example, a Chinese local subscriber would not be allowed to use the local data services of the DataX cloud deployed outside China as this might break local China law.

In accordance with another embodiment of the present invention, if user device 102 is registered in NTT DoCoMo network in Japan, the client knows the location of the device due to the cellular registration of the device and identifies that Softbank in Japan is the only local partner operator from the list of local operator partnerships in Japan. The client will then correspondingly configure the device to use 4G access technology, set a local breakout APN, and select the Softbank operator in Japan so to establish a data session on a local breakout on a virtual profile of the Softbank operator.

In accordance with various embodiments of the present invention, since APN selected is a local breakout, the DNS resolution of the APN points to a local gateway of DataX service. This local gateway could be the member operator's GGSN/PGW, but for easier deployment, consistency and flexible control, DataX service uses its own local gateways (e.g. gateway 110). Each member operator DNS will have primary and secondary pointing to these local gateways.

Rather than changing member operator's DNS configuration, local gateway is required. In accordance with an embodiment of the present invention, the member operator DNS forwards the LBO APN resolution to DNS of gateway 110, which then dynamically selects LBO gateway based on the DNS origination address. In accordance with another embodiment of the present invention, the GTP-C traffic is centrally located in regional local gateways. However, the regional local gateways redirect GTP-U traffic to the closer local gateway based on the originator address.

The present invention focuses on covering as many countries and users as possible. In accordance with various embodiments of the present invention, the DataX provider, may reward the early-bird operators in a country, an exclusivity period (e.g. 6 months). Alternatively, such an operator may be given a branded sponsor for any dataX users (including local competitors) of the same country. For example, if AT&T carrier in USA is a DataX operator, AT&T logo can appear in the DataX app (i.e, interface) downloaded by any users including Tmobile, Verizon etc. Furthermore, the AT&T provider may offer discounts on retail data rates offered by selected (e.g Mexico, Singapore etc.) or all ecosystem partners to the competition (e.g., Tmobile, Verizon) or all USA customers (i.e., including AT&T customers).

The merchant operator logo will be dynamically inserted for all users of the country where the merchant operator is based. If the merchant is a group (e.g. Orange), then the logo can be dynamically inserted for all users of the countries where the merchant operator group provides network services.

It will be apparent to a person skilled in the art that that similarly the present invention can also be used to sponsor enterprise logos with discounts and durations. For example, Mastercard can sponsor discounts with a duration on retail data rates offered by selected or all ecosystem partners. In this case, DataX application with have these sponsors logos.

In accordance with an embodiment of the present invention, the interface on user 102's device (i.e. the DataX application) is distributed from application stores on iOS or Android or Windows platform, or from OTT apps/players, such as Uber or Facebook.

The present invention provides four possible approaches for integrating with OTT players:
1. The OTT app (e.g Facebook) and the DataX app reside individually on the same user device and the OTT app invokes the DataX app for local data service from DataX
2. The OTT app (e.g. Uber) has the DataX app embedded as an SDK and the DataX app interfaces with the DataX backend server (gateway 110). Thus, the user 102 relationship and payment is handled via gateway 110
3. The OTT app has its own device front end and interfaces directly with the DataX server (i.e. gateway 110) via OTT backend. Thus, the user 102 relationship and payment is handled via gateway 110
4. The OTT app has its own device front end and will interface directly with with the DataX server (i.e. gateway 110) via OTT frontend. Thus, the user 102 relationship and payment happens via gateway 110

In all above explained approaches, the OTT can add its own margins or retail prices at each merchant operator or give discount on overall retail price with or without sponsorship. The revenue can be shared with DataX service provider or even with DataX partner operator.

In accordance with another embodiment of the present invention, in each country the partner operator plan may have a free DataX service plan with a limit of X MB (e.g. 20 MB of data per day). In such a case, the user 102 may only use this plan to access local data services, such as purchasing a plan and chatting with help desk etc. When the user 102 reviews plan, there is no need for pay and go straight to activation. After activation, the plan would still be in plan list with metering. When user 102 buys a paid plan, all usage would be counted against the new plan when the plan is activated. When the paid plan is consumed, user 102 can go back to the free DataX plan to buy additional plans. The old usage will continue or can be reset to zero each time a new plan is bought. If user 102 tries to select and activate a new free DataX service plan, the BSS will inform user 102 there is a plan already used within the last 24 hours. User 102 is advised to use the plan where there is still balance left or wait until another day. The free DataX plan can also be achieved via social media promotion both referrer and referred.

In another embodiment of the present invention, DataX approach allows the partner operator makes money on breakage, e.g. if the sale of 2 GB 3 days plan is 10USD, but the user only used 300 MB, the operator essentially saves the breakage of 1.7 GB.

In accordance with another embodiment of the present invention, each country partner can also have their own free plan for 1st time or X time users. User 102 can use this plan to access Internet free of charges. When user 102 reviews plan, there is no need for pay and go straight to activation. After activation, the plan would still be in his plan list with metering. The plan can only be used for first X time. If user 102 tries to select and activate a new free internet service plan beyond X times, the BSS will inform user 102 all X times used up and advise him/her to buy a new plan.

In addition to country plan, there could also regional and group plans, e.g. Asia plans, Europe Plan, Multi-Country Plan, Vodafone Group plan etc. In each merchant plan, there can also be data plans and sponsored plans. When sponsored plans are selected, user 102 goes to select sponsor choices. The sponsor allows user 102 to use the sponsor service for free and each time there is a transaction with the sponsor, the sponsor will also offer a free Internet plan.

It will be apparent to a person skilled in the art that the communication exchange is not operating as a MVNO model but as simply an electronic retail distribution model for operators tailored for locals, travelers and enterprises without a new SIM for user 102. Although, it is trading local rate data service, it does not offer customer care to end user communication service. This is very similar to other communication exchanges like eBay, Priceline, selling car rentals/hotels where these trading services do not provide customer care for the hotel or car service. As a result, the customer care for end user communication service is still with the serving or home mobile operator. This is similar to car rental bought through Priceline where car service is still a responsibility of the car rental company.

Notwithstanding, communication exchange 110 has its own customer care for handling complaints about the trading service rendered by mobile operator at exchange 110, similar to customer care in Priceline or Hotel.com. As the users and merchants' financial transactions are going through the exchange 110 as a broker, similar to issuing/acquiring banks of credit cards for charge backs, the trading service would also handle refunds in case the user service is not rendered for the paid packages. In the case, the refund is cascaded as well. The trading service would refund the users and the operators/merchants would need to refund the trading service including all transaction fees.

In accordance with one embodiment of the present invention, if the seller is a user in addition to an operator, then the refund process would only be done by exchange 110 as the user might lose opportunity to sell to another buyer and the user is not at fault for any service issue.

In accordance with various other embodiments of the present invention, the exchange 110 (i.e. DataX server or simply DataX) allows interchangeable retail data plans across visitor group and alliance operators (e.g. Singapore & Malaysia, US & Mexico, Orange Europe, Bridge) or regions (e.g. Europe, Asia, Singapore-Malaysia-Thailand). Hence, if a DataX subscriber bought a data plan at a merchant/partner operator, the plan could also be used in other merchant operator(s). These operators associated with such a plan are viewed as associated operators. When a subscriber is using its retail data plan bought from any associated operator, the BSS backend will check if the subscriber already had bought an active plan associated with the current operator or an associated operator's data plan. If it is, the subscriber can use and deduct usage as if the associated operator is the operator where he bought the plan. The business model of multi-operators price plans can be that either revenue gets evenly distributed among all involved merchant operators, or it's more for the selling merchant operator or simply based on usage. The former two models are simpler than the third model.

Instead of associating a multi-operator or regional plan with a merchant, the present invention also makes it possible to have a regional/multi-operator plan independently. In this case, the plan will be presented under a group or region heading. For example, under regions (instead of countries) or groups, there will be a bridge/connexus plan, e.g., Europe plan, North America plan or an Asia plan, etc. Each plan details explains the coverage of operators involved. The revenue can still be evenly distributed or based on the usage.

In accordance with another embodiment of the present invention, DataX also allows the merchant operator to offer to its own subscribers for on-demand data plans with a global consistent user experience OTT. This is useful for users running out of monthly data plans or people just want to do on-demand small usage plans which are generally significantly more expensive than monthly plan on per byte basis. It also allows the users to buy group or regional plans on-demand as well from home operator.

After the buyer activates the local package and visits the country, HPMN 104 helps to steer the roaming user 102 to the operator of the data package. The buyer accesses VPMN 106 where credit control is made with exchange 110 and alerts are communicated with exchange 110 and the buyer.

The present invention in its various embodiments, offers either public or private DataX cloud network. In case of a private cloud it's owned (jointly or solely) at a group or country or even operator level. For private cloud, the member operator can control its retail data price plan for its own associated operator subscribers, the DataX app logo, the private BSS API interface although attribution to DataX is maintained. The private cloud may not involve local node deployment, DNS configuration by merchant member if the home operator provides the LBO APNs, though each merchant member would still need to filter out DataX CDR based on the LBO APNs to avoid charging to HPMN 104. The private cloud may also be connected to Public cloud so that subscribers of one member of either cloud could roam and use plans offered by other cloud. The private cloud owner can also share service revenue with DataX service provider for the usage of their cloud. The downloadable DataX app by the subscribers of the private cloud owners can also dynamically insert private brands of the owners. The API of the private cloud will also expose the public cloud API so that the private cloud can expose the API to its business customers and partners such as OTT players to derive new applications that leverage both private and public clouds. The public clouds can provide the private cloud interfaces to access each other merchant's prices. The private cloud can be completely or partially white labelled from DataX app, API, SDK, merchant portal, BSS, local infrastructures.

In accordance with other embodiments of the present invention, the location update proxy provides an HPMN independent solution to handle users who are not data roaming enabled. It cannot distinguish between data roaming not allowed as a steering decision by the home operator or the ones that are simply not roaming enabled. In such case, the HPMN support is needed. As DataX service at VPMN operator requires data roaming supported by the inbound roaming device, this could be a restriction for roamers of countries where data roaming is not enabled by default, such as India, China and Taiwan etc. While such roamers could go to operators to enable roaming, the procedure in some countries is not very conducive. By providing or allowing outbound local DataX service, at least home operators can share some revenue from DataX service on outbound local DataX transactions. This helps the operator against competition with operators that do not have good data roaming rates with partners.

The DataX works without roaming enablement, by having HPMN 104 deploy gateway 110 in its network that intercepts and relays roaming data registration message with home network HLRs from allowed visiting networks of DataX service offering as configured and controlled by HPMN 104. On receiving roaming profile on data registration, gateway 110 bypasses the response to the serving network without being in the loop subsequently. Upon receiving roaming not allowed on data registration from any allowed DataX offering destinations, gateway 110 reinitiates a new relay message to HLR-H 118 by mapping SGSN-R 112 to a home operator address so to fool HLR-H 118 to download profiles as if the roamer is at home country. Once the profile is received, gateway 110 removes the home operator non-local breakout APN and insert a local breakout APN (if not there already) and then relays the modified profile to the SGSN-R 112.

In this way, user 102 can still use local breakout DataX service at VPMN 106. The gateway 110 can also enable voice and SMS roaming this way based on home operator configuration. In particular, HPMN 104 can choose to enable MT voice and SMS only or MO and MT voice SMS or just SMS. With voice and SMS enabled some way, HPMN 104 can avoid roamers that swap home SIM out and can additionally get some roaming revenue in voice and SMS in some capacity. Even without voice and SMS roaming enabled in any capacity, HPMN 104 can still share data revenue (even if it is offered by a visiting operator).

The present invention also provides local data services for connected devices such as connected car, smart watch or any other IoT device. In accordance with various embodiment of the present invention, the connected device, such as a connected car owner, can also use DataX app to buy on-demand plan with a local dataX member operator. In this way, SIM in the connected device does not need to be an eSIM or to have a local profile but just on a roaming IMSI—permanent roaming one in general. Since the owner might already have bought a data plan with the connected device company (e.g. Mercedes) on some operator coverage (e.g. AT&T, Tmobile), the owner might want to buy another operator data plan (e.g. Verizon) independently or a plan that shares with the car company data plan. The company device plan might be at 3G and the new operator plan could be 4G from the same operator. For example, the car company device plan covers 3G of AT&T and Tmobile, the owner could buy a shared data plan of 4G of AT&T (or Tmobile or both).

Since connected device could be on a permanent roaming IMSI, to share a (permanent) roaming data plan with a local data plan as offered by DataX of the visiting local operator, the DataX offers a sharing plan price by a visiting operator as presented to relevant IMSI range associated with the connected device. In this way, a connected car can present the dataX offering to the car owner, where the car owner can have a list of different operators who offer data sharing plans. When a subscriber chooses such a sharing plan offering with an operator, he pre-pays the fee for sharing. The fees would be recurring in general, such as a monthly fee, but prepaid ahead in each month. The subscriber can choose to explicitly opt in/opt-out per month. For any usage by the subscriber at VPMN 106, dataX service will sponsor for it by paying VPMN 106 but deduct the usage against the roaming IMSI data plan. The visiting operator can also share the transaction fee of the shared data plan instead of charging for actual usage to the DataX service provider. The subscriber's DataX local breakout usage will go via the gateway 110 where the BSS associated with gateway checks if user 102 has bought the shared device data plan, in which case BSS will instruct the gateway to tunnel the data path to the address of the gateway of the roaming IMSI plan, which could be the same gateway. The gateway of the roaming IMSI plan can then deduct the common usage against the roaming IMSI plan.

In accordance with another embodiment of the present invention, in addition to deploying outbound roaming gateway for auto-enablement of data roaming of non-data-roaming subscribers at visiting merchant operators and steering DataX subscribers to the merchant operators they bought the packages, the home operators can also enable a LBO APN profile for subscribers at granted or favored merchant operators. Furthermore, the home operator may block any data sessions on such LBO APNs (e.g. not allowing LBO APNs at its GGSN/PGWs) from any visitor operator. In this way, there is no need to deploy probe and DPG at merchant operators who only wish to offer dataX to such home operators' subscribers. The home operator can resolve the APN to point to the dataX cloud gateways.

The LBO APN can be added to HLR-H 118 for all roaming partners or based on allowed merchant operators (e.g. merchant ecosystem to which the home operator is a member of), or dynamically added (if the LBO APN is not in HLR profile for subscribers) or removed (if the LBO APN is already in HLR in all subscriber profile) via a probe/an-path signaling gateway and DPG at home operator.

Since hotspot and 4G LTE APNs could be different from 3G APN, it is important for home operator to have same LBO APNs at hot spot and 4G LTE level. Otherwise, home operator profile should have a LBO-hotspot or LBO-LTE APNs which can be DNS-mapped to the dataX local gateways by the merchants.

Since LBO APNs would not be provisioned/allowed at home operator GGSN/PGWs, it is easier to provision LBO APNs for all subscribers for all roaming partners. Then whichever merchant including the home operator has implemented the LBO APN DNS resolution to the Data infrastructure Gateways (GGSN/PGWs), it will be routed via these gateways and whose data sessions would then be controlled by the associated OCS/BSS/PCRFs of the gateways.

In accordance with another embodiment of the present invention, for a merchant operator to offer different prices for different home operators' subscribers, the offer can even be location specific. For example, a cheap offer can presented at airport only, ideal for inbound transit customers, such as Dubai where there are about 70 million transit visitors a year. Another example, is all US airport offerings for a month.

For APN-change based approach, the logic of profile modification for DataX subscribers remain the same as previous invention from the current inventor. On the data session side of using a plan however, during the data session (initiation and update) of an inbound roamer, the location information (routing area id, tracking area id, SGSN/SGW address, cell ID etc. depending on granularity required) is also compared with the location of the plan the inbound roamer bought (in addition to country and network information) and activated. In case the area of plan includes location area of the data session, the data session would be granted for further access. Otherwise, user would be alerted via the DataX app for the reason of failed data access. It would be apparent to a person skilled in the art that when SGSN changes or data session changes due to location information change, the above logic of checking against the location specific plan would be implemented again.

Similarly, in non-APN change approach, when a GTP control session of an inbound roamer's data session is proxied via a DataX local breakout gateway 110, the location information (routing area id, tracking area id etc) of the control session is also compared with the location of a plan the inbound roamer bought. In case the area of at least the bought plan includes location area of GTP control session then local break out gateway engages SGSN in both control and user data payload sessions against the plan. Otherwise, after local breakout gateway relayed the control session to home operator data gateway and back to the serving gateway, the local breakout gateway would not be in either subsequent control or user data payload sessions. In case the local breakout session is updated, if the new location information is not covered by the current active plan, the session would be relayed home or terminated based on a simple configuration.

When a home routed session is updated, if the new location information is covered by the current active plan, the session would still be home routed, unless the home routed session is relayed via the local break gateway always in both control and data payload sessions.

Following embodiments of the present invention explain various additional aspects of implementation of the local data services in accordance with various embodiments of the present invention, via the CloudSIM Hub approach.

In accordance with another embodiment of the present invention, cloudSIM hub 120 implements a pure network based solution to segregate and route the traffic to right operator network. The cloudSIM hub 120 leverages the OMACP based device management function in conjunction with cloudSIM applet to detect and notify the user device's IMEI. This is helpful in avoiding situations where in smartphones (Android or iOS based), automatic configuration of APN happens when IMSI is changed. In such cases the dual or multi-IMSI solutions fail to segregate the network traffic generated by usage from hub operator's subscribers and from local subscribers from the hub operator, whose IMSI is used to avail this service.

In some cases when subscriber uses an Android or iOS or similar smartphone, when IMSI is changed, the APN is also changed. When cloudSIM Applet switches from Home IMSI to any partner IMSI from ecosystem, the APN of partner network is configured. Hence, subscriber cannot use HPMN data services unless client APNs are re-configured or the data traffic is re-routed to client network.

To avoid this situation, in accordance with an embodiment of the present invention, during GPRS registration on new IMSI (once cloudSIM applet switches), the cloudSIM hub changes following parameters in MAP ISD message to facilitate data routing through VPMN:
Change the APN-OI Replacement parameter in GPRS Subscription Data
Change APN-OI-Replacement parameter (UE level) in EPS Subscription Data

This feature is supported in most of the latest SGSNs (3GPP Release 8 and later) and hence it is desirable way to handle common APNs cases for VoLTE (using VoLTE default APN).

In LTE case, user devices get connected to one or more Packet Data Network (PDN), such as the Internet. The PDN Gateway (P-GW) interconnects LTE to the external PDN. Therefore, as part of the PDN Connectivity process, the user device may request an APN, or MME might select a default APN. The MME uses the APN to identify the P-GW that will be selected for connectivity to the PDN of interest. An APN may be presented in the form APN-FQDN (Fully Qualified Domain Name) and is case insensitive. APNs have two main components. APN Network Identifier (APN-NI) which is a mandatory field; while the other component is optional and is called the APN Operator Identifier (APN-OI).

If the APN-OI-Replacement field Attribute Value Pair (AVP) is present in the subscriber profile that is returned by the HSS to the MME in the Update Location Answer (ULA), then the APN-OI field will be replaced by the one provided in the subscriber profile.

Typically, such replacement is done in the case of “non-roaming and home routed roaming” case. An example of APN-OI replacement would be:

Given:
APN-NI: internet-4
APN-OI replacement field: north.mnc111.mcc222.grps

The following will be performed while deriving the APN-FQDN:
“apn.epc” will be placed between the mnc111 and its preceding label.
“0.3gppnetwork.org” will replace “.gprs”

The resulting APN-FQDN:
internet-4.north.apn.epc.mnc111.mcc222.3gppnetwork.org

In accordance with another embodiment of the present invention, for cloudSIM LTE workflow, CloudSIM hub 120 is in path of Diameter Update Location Answer message and populates the APN-OI replacement AVP with correct value to facilitate routing of data traffic through cloudSIM hub 120 by VPMN. The cloudSIM hub 120 also can also add a wildcard APN in place of client network specific APNs.

In case of SIM OTA technology a common technique is to determine that the OTA packet is delivered to SIM card is implementing Proof of Receipt (POR) or Proof of Execution (POE). However, there are limitations in some of the operator networks, especially in SMSC to implement POR/POE which in turn impacts solution old cloudSIM solution relying solely on SIM-OTA function. The cloudSIM hub 120 of the present invention, overcomes this dependency by implementing an independent POR/POE mechanism in cloudSIM hub 120 to determine if the OTA packet is delivered correctly to cloudSIM applet in the SIM card of subscriber's device. Once a dynamic IMSI is OTA downloaded to cloudSIM applet, the cloudSIM DIA platform start tracking if there is a registration request from the same dynamic IMSI coming to cloudSIM hub 120. If there is no registration attempt seen within a configured time, the DIA platform assumes that OTA operation to download new IMSI failed. Then DIA platform re-initiates the OTA download of same dynamic IMSI to cloudSIM applet.

In some cases, the subscriber's IMSI is changed to a default IMSI via the configuration file. The default IMSI is selected from a sequence of IMSIs in preference order or random order, until one IMSI is successfully registered with the visited network. In accordance with an embodiment of the present invention, the configuration file indicates to dynamically obtain an IMSI. In this case, the SIM is first registered with the default IMSI for the roaming location and then the SIM will request an IMSI via a USSD or SMS or other bearer channel (e.g. WiFi, GPRS, LTE etc.) for a dynamically assigned IMSI for the roaming location. The request then comes to the default IMSI hub, which then consults a central worldwide system or a system responsible for the IMSI assignment of the location (corresponding with the home IMSI) for a dynamically assigned IMSI for the roaming location for the subscriber. Thereafter, the IMSI is sent via OTA via USSD, SMS or other bearer channel in response to the IMSI request. The SIM then re-registers with the newly assigned IMSI.

In order to manage the billing, the cloudSIM service is set up a wholesale broker by Globetouch, whose IMSI hub partners' IMSI and rates are resold with markup to client operators (including MNO, MVNO, and MVNE etc.). The subscriber is billed based on rates received from the hub operator of cloudSIM ecosystem. In order to handle billing for TAP and NRTRDE, cloudSIM hub charges a markup for the leg from the roaming partner IMSI to cloudSIM hub IMSI with roaming partner rate. Further for the leg from cloudSIM hub IMSI to client operator with markup from cloudSIM hub.

In accordance with an embodiment of the present invention, cloudSIM hub offer IMSIs with daily usage cap e.g. an IMSI where unlimited data usage is allowed paying a flat rate e.g. USD 5 per day. The cloudSIM workflow accommodates the special handling of these IMSIs in terms of provisioning, usage monitoring and wholesale billing handling thus providing flexibility to the MNOs to offer best tariff plans to attract more subscribers and service usage.

The cloudSIM hub offers seamless integration with MNO network with minimum integration points. This ensures minimum time to market the services for the client MNO. The cloudSIM hub has an integrated SMSC function to deliver OTA SMS payload to applet and also MO SMS trigger from applet about terminal switch (for IMEI change). This minimizes the time of any 3rd party SMSC integration. It also offers a transparent mode OTA API to integrate with 3rd party OTA platform owned by client MNO where cloudSIM hub creates OTA payload and 3rd party OTA platform just to pass-thru that payload encrypted with right OTA key. This minimizes the time for 3rd party OTA integration with cloudSIM application.

In accordance with various other embodiments of the present invention, the cloudSIM hub 120 offers optimal data routing capability to implement:
a) Optimal routing of user data traffic to local GGSN/PGW depending on current location of device
b) Offer superior user experience by ensuring low latency & higher bandwidth
c) Meet any regulatory or commercial requirements to keep user data within national boundaries

Key benefits of this feature are:
Enables local retail offers for Connected Cars
Provides local internet peering for other M2M devices and applications
Superior user performance for connected devices

The cloudSIM hub approach offers a seamless and highly effective ways to create and manage services to all members of the cloudSIM ecosystem e.g. MNO clients, enterprise clients, ecosystem partners and the end subscribers. The cloudSIM offers a client portal to offer an easy to use interface to a client MNO create service profile seamlessly by referring the service related information about the cloudSIM service e.g. coverage, tariff, special offers, country specific regulations etc. There is an automated workflow to create the service profile for the clients. The cloudSIM service similarly offers a donor portal for ecosystem partners to create their service profile, an enterprise portal for enterprise clients to create their service profile and a device application for the end subscribers to manage their services in most seamless and effective way.

In accordance with an embodiment of the present invention, the cloudSIM applet stores IMSI and other subscription data (e.g. SMSC Address, Service Provider Name, List of MCC-MNC where the particular IMSI should work) as part of Java Applet buffer so that there is no need to create proprietary Elementary Files separately in USIM file system. The subscription data is fully managed by the cloudSIM applet and any OTA downloads of additional IMSIs are directed to this applet. These enhancements ensure the CloudSIM Applet can be ported to any SIM card compliant to Java Card standards from any SIM card manufacturer supplier with minimum testing effort.

In accordance with various embodiments of the present invention, the SIM card used to implement the cloudSIM service of this patent application, has a standard UICC (with 4G/3G USIM function along with ISIM function in certain cases) but is capable of storing multiple IMSIs of different MNOs or MVNOs. The applet should be able to store multiple IMSIs. The number of IMSIs will depend on the size of SIM card being used but at least 10 IMSIs should be supported. All the IMSIs are possible to update via OTA. The preferred embodiment of the present invention is to store the IMSI slots as part of Java Applet buffer so that there is no need to create proprietary elementary files separately in USIM file system. The IMSIs and related parameters should be fully managed by the STK applet and the backend systems like DIA platform and OTA platform need not to store the image of the IMSI slots (i.e. which IMSI is in which slot and which free slot to update when OTA downloading a new IMSI).

The key functionalities of the applet high level are:
Perform IMSI management
Receive and interpret location information from ME using standard SIM ToolKit events
Inform DIA server of location over USSD or MO SMS
Receive OTA messages and process IMSI updates (add, update, delete IMSI) from DIA server

Perform IMSI selection
Store multiple IMSIs (preferably within Applet buffer instead of proprietary SIM Elementary Files)
Stores MCC—IMSI mapping for all IMSIs with Applet to decide which IMSI to be used in which country
Switch from one IMSI to another IMSI on location change as per workflow and update relevant SIM Elementary Files (e.g. EF IMSI, EF SMSP etc.)
Issue Refresh to make device select the new IMSI as active IMSI

Subscriber Interactions
Display text for specific use cases
SIM ToolKit menu for IMSI switching manually (enabled in test cards only)

In accordance with various embodiments of the present invention, cloudSIM hub 120 implements the IMSI selection logic in following manner:
When the subscriber switches on the device in a roaming location, the STK applet determines the location and requests for new IMSI for current location from the cloudSIM's DIA platform.
The DIA platform allocates a dynamic IMSI depending on subscriber location and OTA downloads the same to applet
The downloaded dynamic IMSI is selected by the applet as active IMSI and same is used for roaming
Once the subscriber moves to another country or comes back in home country, where the downloaded dynamic IMSI is not valid, the dynamic IMSI is deleted from the SIM card. The same dynamic IMSI goes back to pool and can be used for another subscriber after a quarantine period.

However, as in order to implement this lot of communications between applet and DIA server is required, which creates additional network traffic and potential failure points as well as may affect user experience due to additional time to OTA download a new dynamic IMSI every time even if the subscriber is visiting the same country repeatedly.

To overcome the issues mentioned above, the cloudSIM applet of the present invention, stores multiple dynamic IMSIs in the applet buffer without deleting any dynamic IMSI as soon as subscriber moves to a different country in use. So, when the subscriber is back home or the subscriber moves to another country served by a different dynamic IMSI, the previous dynamic IMSI still remains with applet and can be re-used if the subscriber goes back to the same country again in future, hence removing the need of OTA downloading another IMSI from same donor.

In accordance with another embodiment of the present invention, the applet in addition to storing basic subscription information like: IMSI, SMSC address, service provider name and list of MCC-MNC where that IMSI should work, also stores additional information like preferred PLMN lists and forbidden PLMN List which are used for enhanced user experience. The applet also stores access control class and administrative data for correct working of the applet. The applet handles additional information elements needed for more advanced SIM cards like SPDI, Operator Determined PLMN List, PS LOCI and EPS LOCI for seamless functioning for these SIM cards.

The applet traditionally uses SIM STK command PLI to retrieve location information (MCC, MNC of network where the device did last register attempt—successful or failed). But as there are devices in market which don't support PLI command and there are devices which don't implement the PLI command correctly. To ensure that cloudSIM applet works in such devices, additional location detection mechanisms are added e.g. read SIM card EF LOCI which also contains MCC, MNC of network where the device did its last registration attempt. Additional mechanisms like periodic location check are added to ensure the applet functions in certain erroneous condition.

The traditional workflow of cloudSIM applet is to try latching on in a roaming location in a linear way, i.e.
try current IMSI (in EF IMSI of SIM card)
if not successful, try Home IMSI
if not successful, try Global Roaming IMSI

This liner workflow takes more time for device to latch on in countries where there is no bi-lateral roaming agreements of home network before it can initiate request for dynamic IMSI. This approach also makes push based implementation complex due to requirement for roaming probe integration to track registration attempts using Home IMSI.

In enhanced version of cloudSIM applet, it is possible to configure which IMSI to be used to latch on in roaming location if there is no dynamic IMSI available with applet. It can be either Home IMSI or global roaming IMSI. As a result, the device can directly latch on using global roaming IMSI where Home IMSI cannot work due to absence of a bi-lateral agreement. For push based approach, if the device always latches on using global roaming IMSI ensures that CloudSIM Hub is always in path of registration attempt and can act accordingly without a probe integration need. In case, there is a country/network where the device must latch on using Home IMSI (i.e. use Client Operator's bi-lateral agreement), the applet can switch back to Home IMSI based on list of MCC MNC where Home IMSI should be applicable. Alternatively, DIA platform can force the applet to switch to home IMSI by downloading the home IMSI as dynamic IMSI or updating the configuration to make home IMSI as default IMSI for the particular roaming country.

In accordance with various embodiments of the present invention, various configurations are introduced in the cloudSIM applet to achieve optimal user experience, especially in cases when the active dynamic IMSI loses coverage:
HOME_MCC_MNC: value of client operator MCC MNC
NoCoverageFlag: Flag set for dynamic IMSI Registration failure
   ON: if a dynamic IMSI of a MCC cannot get connection for the country after ToggelCounter is crossed in NoCoverageTimer
   OFF: Initial state
NoSwitchIMSIFlag: Whether to switch the IMSI to HOME/Global IMSI or Not if the current IMSI is an applicable dynamic IMSI in roaming country (System level flag)
   ON: Applet will not change IMSI even no coverage due to regulatory reason
   OFF: Applet will change IMSI
NoUSSDFlag: If USSD support is required for IMSI management (System level flag)
   ON: means no USSD request to be sent to DIA for dynamic IMSI
   OFF: means USSD request to be sent to DIA for dynamic IMSI
ToggleTimer: Timer for toggling between IMSI OR activating NoCoverage flag (6 min or 3 min)
NoCoverageTimer: Timer for dynamic IMSI to be successfully latched on
ToggleCounter: Number of toggle done between Home/Global IMSI and Dynamic IMSI

Furthermore, in existing applet implementations, when the applet receives the new dynamic IMSI from DIA using OTA SMS, it writes the dynamic IMSI along with SMSC and SPN to respective SIM card elementary files. But, if the device is busy in a call (which can be frequent as people tends to make calls just after switching on the device once they land in new country) or any other activities (e.g. SIM Toolkit Busy), the Refresh command will fail. As a result the IMSI (and SMSC, SPN) values in SIM card EF may be different from the one with device. This situation will persist till next power on cycle of the device (or any other subsequent Refresh).

In accordance with various embodiments of the present invention, the cloudSIM applet is enhanced to overcome above situation:
The applet sets a poll interval of e.g. 30-60 Seconds so that the applet gets the status from terminal after in poll interval
Once the applet receives the OTA payload with the dynamic IMSI (and other parameters), it doesn't write the content to respective SIM EFs immediately. The applet waits till the poll interval expires.
Once the poll interval has expired, the cloudSIM applet sends PLI Proactive SIM ToolKit command to check if the device is busy.
If the device is busy it initiates the IMSI switch workflow else it starts another poll interval.

In accordance with an embodiment of the present invention, the cloudSIM applet implements a new configuration to control the applet behavior regarding switching to Home IMSI (or Global Roaming IMSI) if the device loses coverage on the active dynamic IMSI for the current location. This feature makes the service compliant to Permanent Roaming Guidelines in certain countries where switch back to home IMSI (or Global Roaming IMSI) is not recommended.

### NoSwitchIMSIFlag

Whether to switch the IMSI to HOME/Global IMSI or Not if the current IMSI is an applicable dynamic IMSI in roaming country (System level flag)

ON: Applet will not change IMSI even no coverage due to regulatory reason

OFF: Applet will change IMSI

When the cloudSIM applet switches from home IMSI to the dynamic IMSI it updates the SIM card Elementary Files with the corresponding values received from DIA platform for that dynamic IMSI. The cloudSIM applet stores the default contents of these EFs in IMSI Slot for the home IMSI and when the applet is back with Home IMSI as active IMSI (in Home Network or roaming using Home IMSI), the default contents of these EFs are re-written by the cloudSIM applet to respective EFs. Some SIM card Elementary Files (e.g. EF HPPLMN Search Period or EF EHPLMN etc.) may get reset to default values when the IMSI gets updated by the applet (e.g. Home IMSI to Dynamic IMSI). As a result, some EF values set specifically for UICC to work in Home Network may be lost. So, it is important to identify such EFs and store the specific values set during personalization against Home IMSI in IMSI Slot and copy the same back to respective Elementary Files when the device is back with Home IMSI as active IMSI (in Home Network or roaming using Home IMSI). A new configuration is provisioned (Switch to Home IMSI on Power on) to control the applet behavior i.e. whether applet should always switch to Home IMSI on every power on.

In accordance with various embodiments of the present invention, the cloudSIM applet is enhanced to support SIM based terminal switch detection. This functionality detects in case the subscriber changes his/her device and store the new IMEI in its database. The IMEI is used to configure cloudSIM service APNs using OMA-CP compliant Device Management Platform to devices which auto-configures APN on IMSI switch.
The workflow to implement above is as follows:
The cloudSIM Applet will store the device IMEI in the applet buffer.
The cloudSIM Applet will subscribe to STK Power On event.
On each device power on, the Applet will get a trigger from device.
Once the trigger is received, the Applet should use the STK Provide Location Information (PLI) command to fetch the IMEI of the device
Then Applet should compare the value with the IMEI value stored in the buffer
   If there is no IMEI in buffer (e.g. new SIM card being used first time), the new IMEI value should be written to buffer
   If the new IMEI value is different from the one in buffer, overwrite the old IMEI value with the new one in buffer
   If the new IMEI value is same as the one in buffer, no action needed and let the old value be there in buffer
If there is a change in IMEI value (case I and II above), the Applet should send a MO SMS with IMSI, Old IMEI and new IMEI value to DIA platform.
The MO SMS can either be sent to SMSC address in SIM card or to a different SMSC Address which is specific to DIA platform. This will be configurable in the applet
DIA platform will received the MO SMS and send a negative Acknowledgement so that Roaming MO SMS is not charged by the VPMN.
DIA platform then updates the IMSI-IMEI mapping data received from Applet in its database
The SIM based Terminal Switch Detection will be configurable in Applet. The workflow will run only if the Applet is configured to run that. The default configuration will be “Disabled”.

Each SIM card contains three standardized files used during location update while roaming. These files are
List of preferred roaming partners
Current registered network
List of forbidden networks

Once the handset is powered on and the current location/network is detected, the SIM Card receives the necessary events from the mobile phone equipment informing the current location of the subscriber. Based on this location, the applet loaded on SIM processes the files provisioned to select the appropriate IMSI and subsequently use that IMSI to register with the appropriate network. In case, the coverage to appropriate network is lost, the file is re-scanned by the applet and the re-selection of appropriate network/IMSI combination is done. However if none of the available network is provisioned to be selected by foreign IMSIs the applet restores the identity to the home IMSI and uses the home IMSI to access the available network.

All throughout the user experience is seamless and non-intrusive. All the operations pertaining to SIM card management, applet download and IMSI management as well as network selection are transparent to the user thus making the entire roaming experience very easy. It will be apparent to a person skilled in the art that all services are available on home number and hence user experience does not change. In addition to this, in selected countries, subject to local regulations, local numbers may be available along with IMSIs which can be used by the end user of the service.

The cloudSIM ecosystem helps the cloudSIM client networks to provide services to its outbound roamers across international borders at the costs much lower than incurred during traditional roaming arrangements. This is done by leveraging use of local/regional IMSIs made available through Globetouch's global cloudSIM alliance. The operators are also benefited
To offer a competitive roaming tariff to subscribers
To overcome competition from international SIM card providers
To tap additional revenue from M2M services which are of global nature e.g. Transportation, shipping etc.
To increase outbound roaming footprint for CAMEL, GPRS or 3G.

The cloudSIM ecosystem also helps the cloudSIM hub operators on following parameters:
Get additional inbound traffic from new networks/subscriber base of the client operators who would leverage the attractive service rates offered by the cloudSIM hubs.
Get additional inbound traffic from cost conscious travellers who prefer to use alternate channels of communication.
Tap additional revenue from M2M services which are of global nature e.g. transportation, shipping etc.
Offer additional outbound traffic to their roaming partners and increase volume offered to these partners to leverage on additional discounts

The additional benefits from cloudSIM ecosystem for the cloudSIM hub operators are given below:
One contract with Globetouch to cover inbound roaming traffic globally from its customers globally.
Operational convenience of standard roaming operations usage transfer using tap files. All other operational items would be same as signing up a roaming partner.
No risk of traffic being steered by roaming partners.

In accordance with various embodiments of the present invention, the communication exchange can also be extended to automatically select a data plan and sells an unused plan for a subscriber should he opt-in so based on the criteria user sets.

In accordance with various embodiments of the present invention, the exchange 110 manages a wallet account for each registered user similar to Paypal or Amazon Payment due to transactional funds similar to Ebay or Paypal. Like the Paypal the account could be backed up by credit card or bank transfer automatically when the balance is running out. Also like the Paypal, the balance could be cashed out directly via a bank card or transfer back to a bank account. The DataX approach supports multiple payment methods (e.g. credit card, debit card, Unionpay, Alipay, Paypal, Applepay etc.) via a single or multiple payment gateways which can also distribute payments to different bank accounts based on application identifiers (e.g. Facebook integration on dataX can be paid first into its bank account).

DataX can also integrate with customized payment methods, e.g. carrier billing, prepaid balance, mobile wallets (e.g. mpesa), voucher (existing mechanism of merchants or newly generated by dataX but sold by merchants or their distributors). For home operator based dataX solution that offers to its own susbscribers, payment method can even be postpaid even though usage is still controlled by bundles.

In accordance with several other embodiments of the present invention, the communication exchange can also be extended to auctioning of data packages, similar to Priceline or Ebay. The present invention allows user 102 to be a seller other than an operator, the auction allows the following possibilities:

a) The buyer can name own price

b) The buyer can bid for a deal

c) The seller can provide an optional minimum price and an optional definite sell price for buyers to bid (within a bid period)

d) The seller can just present a non-negotiable pricing

e) There can be multiple operators' offering to choose.

However, the auction extension in the non-operator merchant seller case continues to be restricted to packages bought via the communication exchange.

During DataX registration via the DataX OTT app, the subscriber enters the MSISDN and receives a one-time code to enter to continue. The subscriber account would be associated with the MSISDN. In generic case, IMSI and MSISDN would not be distinguishable. However, there are many variations the MSISDN account approach provides.

The BSS stores an association of MSISDN and a list of IMSIs, including home IMSI, sponsor IMSIs and even dynamic IMSIs. If an IMSI changes association to a new number, the old association with another number would be removed.

Anytime a MSISDN is detected from a DataX data session, the associated IMSI will be associated with the MSISDN and disassociated from any other MSISDN if any.
1. Different IMSI and Single MISSDN
2. Dynamic IMSI SIMs

During subscriber's roaming registration at a merchant operator, the IMSI of the subscriber might actually vary based on roaming destination, to check if the IMSI has a plan at the merchant operator, the MSISDN associated with the IMSI in the roaming registration profile is actually checked against a plan at the merchant operator bought by the subscriber.

The new IMSI and the MSISDN association is also stored.

1. Lost SIM

When a SIM is lost, the subscriber can still obtain a new SIM/IMSI with the same MSISDN without losing his account or the plans he bought or used before.

2. Single IMSI Multiple MSISDNs

There are use cases where a single IMSI SIM might have different MSISDNs. Since different MSISDNs might indicate different purposes (e.g. personal vs business, local vs international) by subscribers, the DataX can still separate subscriber's merchant plans based on their MSISDNs.

If a subscriber wants to have different numbers on the same plan, he would need to verify each number in the registration process.

3) Multi IMSIs and Multiple MSISDNs

There are also use cases where a Multi-IMSI SIM might have different MSISDNs. Since different MSISDNs might indicate different purposes (e.g. personal vs business, local vs international) by subscribers, we can still separate subscriber's merchant plans based on their MSISDNs.

If a subscriber wants to have different numbers on the same plan, he would need to verify each number in the registration process.

4) Dynamic Local MSISDNs

There are also use cases where a SIM might have a temporary MSISDN or even one that is not known to the SIM subscriber at some destinations. In many of these cases, home MSISDN was still received at the merchant operator first before a temporary one was sent.

During a subscriber's roaming registration at a merchant operator, to check if the IMSI of the subscriber has a plan at the merchant operator, the home operator MSISDN associated with the IMSI in the roaming registration profile is actually checked against a plan at the merchant operator bought by the subscriber.

If home MSISDN was not received at the merchant operator and the MSISDN profile of the roaming subscriber is changed to a temporary one, DataX only uses a combination of MSISDN and IMSI to ensure one of them gets a mapping. Basically tries to use the MSISDN to locate a plan for the subscriber and failing that uses the IMSI.

The following generic logic applies to all cases: When a subscriber buys a plan or accesses the DataX service, the DataX BSS records both the MSISDN and IMSI used in the purchase or access as the GGSN/PGW will capture both the MSISDN and IMSI of the data session.

Then, when an inbound roamer is registering at a merchant operator, to determine if the roamer is a DataX subscriber of the merchant or not:
a) First is to use the MSISDN from the inbound roamer's registration profile at the merchant operator to find a non-expired merchant plan for the roamer at the location
b) If a plan is found, then the inbound roamer is considered a dataX subscriber at the merchant, corresponding actions would be applied (e.g. in the APN change approach, a VPAA flag is inserted in APN of roamer profile.
c) If no plan is found, then DataX uses the IMSI from the inbound roamer's registration profile at the merchant operator to find a non-expired merchant plan for the roamer at the location
d) If a plan is found, then the inbound roamer is considered a DataX subscriber at the merchant, corresponding actions would be applied (e.g. in the APN change approach, a dataX/LBO APN would be inserted in the roamer profile).
e) If no plan is found, then the subscriber is not considered a DataX subscriber at the merchant operator.

In accordance with various embodiments of the present invention, if HPMN is supportive, the DNS configuration on the DataX APN can also be done at home operator side. Then DNS query will recursively goes to home operator DNS server which can be configured to point to a GTP proxy such as the dataX data gateway. Also with HPMN support, HPMN can even define in subscriber profiles the DataX APN, there is even no need to probe or DPG (Dynamic profile gateway) at the merchant side.

In accordance with various embodiments of the present invention, in addition to helping manage the steering of roaming to dataX merchant for its outbound roamers, the home operator also helps out in setting the VPAA flag of the DataX roamer roaming at a merchant partner. The VPAA flag can be dynamically set on HLR via an HLR AP or by a dynamic profile gateway (on an active probe or passive probe interface) based on some subscription information of the subscriber for the special DataX service and plan. In the case of latter, the deployment can be similar to the one deployed at a merchant operator, except it is deployed in the home operator. There is no need for merchant side deployment of probe (active or passive) and dynamic profile gateway.

However the merchant still needs to define DNS resolution on the VPAA flagged APN to point to a DataX gateway. The merchant can filter out the CDR from TAP processing based on the VPAA flag and share the transaction revenue with the home operator. The transactional DataX plan price can be defined by the merchant or home operator and paid into either party first. Alternatively the merchant can still charge home operator as normal or special (based on the VPAA flag) roaming wholesale rates (without doing any CDR filtering) via normal TAP processing. Home operator in this case defines the transactional price of DataX plans and doesn't share revenue with the merchant

The advantage is that the home operator outbound roamers do not need to change APN nor need to manually select a merchant network although he still needs to activate DataX subscription. As a result, there is no risk of accidental user leakage of data roaming usage due to personal hotspot or 4G LTE roaming, which might have hidden APNs that could not be changed.

In addition to helping out managing steering of roaming to the DataX merchant for its outbound roamers, the home operator can also provide a DataX service to its outbound roamers at partner merchants without the merchant partner doing anything. In this case, the outbound roamers data control session will be routed to a home operator data proxy. The proxy will direct the data user traffic gateway to local breakout dataX gateway if the outbound roamer is a DataX service subscriber or has a bought a plan. Otherwise the proxy will direct the data user traffic gateway to the home operator normal gateway. The proxy need be defined to only handle outbound roamer data control session messages.

In accordance with an embodiment of the present invention, the data package bought could be application based charging. For example, only Facebook is free with the bought data package. Or the data package would be unlimited for the fixed price but with speed downgraded to 2G. VPMN 106 could also allow a URL access for free for the communication exchange 110. This will be automatically updated into the software interface for accessing the store front when the user 102's device is accessing the network.

In another embodiment of the present invention, the communication exchange can be extended to support VoIP by offering multiple number VoIP service where a member mobile operator of the ecosystem can contribute a local number for roamers or non-member customers to permanently or temporarily use for making or receiving calls and SMS. Moreover, the communication exchange can bind incoming calls to a user's number of the member mobile operator over IP to reduce roaming cost.

It yet another embodiment of the present invention, a travel enterprise (e.g. airline, hotels, tourist business including shopping and restaurants etc.) software application is built on the communication exchange API so that the cost on the usage of user 102 on the software application in roaming or local environment including VoIP calls can be covered by the enterprise for the communication exchange. In this case, the enterprise does the B2C advertising and own services including free or sponsored data roaming and VoIP calls. The enterprise also does cross advertising and B2B trading among related enterprise on the exchange, for example, Chase Bank advertise on Nike App, hotels on airline apps, car rentals on hotels etc. In a continued embodiment of the present invention, OTT apps such as Skype, Facebook, WhatsApp, Google voice etc. are built on the communication exchange to leverage a sponsored data plan in return for advertising revenue. Moreover, all the buyers' traveling destinations, data usage statistics, buying expense etc., and all the sellers' unused data amount statistics and selling operators etc. provide valuable analytics for advertising, traveling enterprise apps and targeted marketing of further trades.

In other embodiment of the present invention, the communication exchange tracks and report application protocols and URLs etc. based on DPI support of VPMN 106. In particular, VPMN 106 provides foot fall data intelligence on travelers, while the communication exchange provides travelers profiles around the world. The combined profile allows traveling enterprises to form targeted advertising on different enterprise applications. If HPMN 104 also participates, more subscriber profile data (on local usage and worldwide roaming usage) is used for better targeted advertising.

However, that all privacy issues are protected in the following ways:

1) Only generic profile data (e.g., male more than 50 years, spending 50 USD a day etc.) is collected and cannot be related to an individual user (e.g. John P. of ABC company)

2) While the generic profile data is collected and shared across enterprise apps for targeted advertising, it is not shared for sign on to avoid correlation-ship with individuals.

The analytics services such generated are used by enterprise including M2M and IoT. In such cases, user 102's mobile's software interface is configured by enterprise admins to track and report all usage information.

It will be apparent to a person skilled in the art that when LBO is chosen, software application residing on user 102's mobile device would configure/select the LBO APN for the device data access profile. When home routing is chosen, the device client would configure/select back the home profile for the device data access profile. In general, LBO APN breakout does not interfere with other services such as CSFB and VOLTE. Nevertheless, for CSFB, LBO is not a concern, while for VOLTE another APN IMS used for local breakout. As devices allow multiple APNs and local breakout sessions, there are no interferences. As VOLTE is still considered as voice roaming even though it is a data service, it would not incur local data package consumption.

In yet another embodiment of the present invention, since the communication exchange operates based on MSISDN, number portability works when changing operators except when the new operator has no roaming relationships with the visiting operator of the bought package. User 102 still will be liable for payment in this exceptional case, similar to no-show cancellation on non-refund, e.g. trip cancelled. However, unlike no-show cancellation policy, user 102 can sell the unused package to other users through the communication exchange. If user 102 changes numbers either on existing or new operators or the user 102 intends to use another SIM, user 102 will still be liable for the payment. However, user 102 can transfer the data package on its new number without incurring any charges. User 102 can also sell it but that would incur additional charges.

In accordance to another embodiment, the number portability feature is used to implement gifting. Unlike number change, the gifting might not verify the gifted party's number although to avoid mistakes, it is recommended to verify it. The software interface manages multiple SIMs accounts to allow user 102 to swap SIMs, as the software interface can switch accounts as buyers and sellers for the correspond SIMs. However, each SIM can only have one account, verified at the time of registration. Once registered, user 102 is free to use the trading service using any SIMs as it can switch accounts on line for trading data packages on the selected account.

In accordance with yet another embodiment of the present invention, the gateway 110 facilitates local data roaming for users using multi-IMSI SIM. The new multi-IMSI SIM has several static IMSIs based on partnership between operators.

It will be apparent to a person skilled in the art, that the present invention can also be applied to Code Division Multiple Access (CDMA)/American National Standards Institute #41D (ANSI-41D), and various other technologies such as, but not limited to, VoIP, WiFi, 3GSM and inter-standard roaming. In one exemplary case, a CDMA outbound roamer travels with an HPMN CDMA handset. In another exemplary case, the CDMA outbound roamer travels with an HPMN GSM SIM and a GSM handset. In yet another exemplary case, GSM outbound roamer travels with an HPMN CDMA RUIM and a CDMA handset. To support these variations, system 100 will have a separate SS7 and network interfaces, corresponding to both the HPMN and VPMN networks. It will also be apparent to a person skilled in the art that these two interfaces in different directions may not have to be the same technologies. Moreover, there could be multiple types of interface in both directions.

An exemplary list of the mapping between GSM MAP and ANSI-41D is described in the table below as a reference.

| GSM MAP | ANSI-41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCATION REQUEST |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTING REQUEST |

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

### Other Variations

Provided above for the edification of those of ordinary skill in the art, and not as a limitation on the scope of the invention, are detailed illustrations of a scheme for proactive roaming tests, discoveries of roaming partner services and discoveries of frauds in roaming using simulated roaming traffic. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent user id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the user telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third generation of mobile |
| ACM | ISUP Address Completion Message |
| ANM | ISUP Answer Message |
| ANSI-41 | American National Standards Institute #41 |
| ATI | Any Time Interrogation |
| BCSM | Basic Call State Model |
| BSC | Base Station Controller |
| BOIC | Barring Outgoing International Calls |
| BOIC-EX- | Barring Outgoing International Calls except to home |
| Home | country |
| CAMEL | Customized Application for Mobile Enhanced Logic |
| CAP | Camel Application Part |
| CB | Call Barring |
| CC | Country Code |
| CDMA | Code Division Multiplexed Access |
| CdPA | Called Party Address |
| CDR | Call Detail Record |
| CF | Call Forwarding |
| CgPA | Calling Party Address |
| CIC | Circuit Identification Code |
| CLI | Calling Line Identification |
| CSD | Circuit Switched Data |
| CSI | Camel Subscription Information |
| DPC | Destination Point Code |
| DSD | Delete Subscriber Data |
| DTMF | Dual Tone Multi-Frequency |
| ERB | CAP Event Report Basic call state model |
| EU | European Union |
| FPMN | Friendly Public Mobile Network |
| FTN | Forward-To-Number |
| GLR | Gateway Location Register |
| GGSN | Gateway GPRS Support Node |
| GMSC | Gateway MSC |
| GMSC-F | GMSC in FPMN |
| GMSC-H | GMSC in HPMN |
| GPRS | General Packet Radio System |
| GSM | Global System for Mobile |
| GSMA | GSM Association |
| GSM SSF | GSM Service Switching Function |
| GsmSCF | GSM Service Control Function |
| GT | Global Title |
| GTP | GPRS Tunnel Protocol |
| HLR | Home Location Register |
| HPMN | Home Public Mobile Network |
| IN | Intelligent Network |
| IOT | Inter-Operator Tariff |
| GTT | Global Title Translation |
| IAM | Initial Address Message |
| IDP | Initial DP IN/CAP message |
| IDD | International Direct Dial |
| IMSI | International Mobile Subscriber Identity |
| IMSI-H | HPMN IMSI |
| IN | Intelligent Network |
| INAP | Intelligent Network Application Part |
| INE | Interrogating Network Entity |
| IP | Internet Protocol |
| IREG | International Roaming Expert Group |
| IRS | International Revenue Share |
| ISC | International Service Carrier |
| ISD | MAP Insert Subscriber Data |
| ISG | International Signal Gateway |
| IST | Immediate Service Termination |
| ISTP | International STP |
| ISTP-F | ISTP connected to FPMN STP |
| ISTP-H | ISTP connected to HPMN STP |
| ISUP | ISDN User Part |
| ITPT | Inbound Test Profile Initiation |
| ITR | Inbound Traffic Redirection |
| IVR | Interactive Voice Response |
| LU | Location Update |
| LUP | MAP Location Update |
| MAP | Mobile Application Part |
| MCC | Mobile Country Code |
| MCC | Mobile Country Code |
| MD | Missing Data |
| ME | Mobile Equipment |
| MGT | Mobile Global Title |
| MMS | Multimedia Message Service |
| MMSC | Multimedia Message Service Center |
| MMSC-F | FPMN MMSC |
| MMSC-H | HPMN MMSC |
| MNC | Mobile Network Code |
| MNP | Mobile Number Portability |
| MO | Mobile Originated |
| MOS | Mean Opinion Score |
| MS | Mobile Station |
| MSC | Mobile Switching Center |
| MSISDN | Mobile Station International Subscriber Directory Number |
| MSISDN-F | FPMN MSISDN |
| MSISDN-H | HPMN MSISDN |
| MSRN | Mobile Station Roaming Number |
| MSRN-F | FPMN MSRN |
| MSRN-H | HPMN MSRN |
| MT | Mobile Terminated |
| MTP | Message Transfer Part |
| NDC | National Dialing Code |
| NP | Numbering Plan |
| NPI | Numbering Plan Indicator |
| NRTRDE | Near Real Time Roaming Data Exchange |
| O-CSI | Originating CAMEL Subscription Information |
| OCN | Original Called Number |
| ODB | Operator Determined Barring |
| OPC | Origination Point Code |
| OR | Optimal Routing |
| ORLCF | Optimal Routing for Late Call Forwarding |
| OTA | Over The Air |
| OTPI | Outbound Test Profile Initiation |
| PDP | Protocol Data Packet |
| PDN | Packet Data Network |
| PDU | Packet Data Unit |
| PRN | MAP Provide Roaming Number |
| PSI | MAP Provide Subscriber Information |
| QoS | Quality of Service |
| RAEX | Roaming Agreement EXchange |
| RI | Routing Indicator |
| RIS | Roaming Intelligence System |
| RDN | Redirecting Number |
| RNA | Roaming Not Allowed |
| RR | Roaming Restricted due to unsupported feature |
| RRB | CAP Request Report Basic call state model |
| RSD | Restore Data |
| RTP | Real-Time Transport Protocol |
| SAI | Send Authentication Info |
| SC | Short Code |
| SCA | Smart Call Assistant |
| SCCP | Signal Connection Control part |
| SCP | Signaling Control Point |
| SF | System Failure |
| SG | Signaling Gateway |
| SGSN | Serving GPRS Support Node |
| SGSN-F | FPMN SGSN |
| SIM | Subscriber Identity Module |
| SIGTRAN | Signaling Transport Protocol |
| SME | Short Message Entity |
| SM-RP-UI | Short Message Relay Protocol User Information |
| SMS | Short Message Service |
| SMSC | Short Message Service Center |
| SMSC-F | FPMN SMSC |
| SMSC-H | HPMN SMSC |
| SoR | Steering of Roaming |
| SPC | Signal Point Code |
| SRI | MAP Send Routing Information |
| SRI-SM | MAP Send Routing Information For Short Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TADIG | Transferred Account Data Interchange Group |
| TAP | Transferred Account Procedure |
| TCAP | Transaction Capabilities Application Part |
| VT-CSI | Visited Terminating CAMEL Service Information |
| TP | SMS Transport Protocol |
| TR | Traffic Redirection |
| TS | Traffic Steering |
| TE | Termination Ecosystem |
| TT | Translation Type |
| UD | User Data |
| UDH | User Data Header |
| UDHI | User Data Header Indicator |
| USSD | Unstructured Supplementary Service Data |
| VAS | Value Added Service |
| VIP | Very Important Person |
| VLR | Visited Location Register |
| VLR-F | FPMN VLR |
| VLR-H | HPMN VLR |
| VLR-V | VPMN VLR |
| VMSC | Visited Mobile Switching Center |
| VoIP | Voice over IP |
| VPMN | Visited Public Mobile Network |
| ATI | Access Transport Information |
| UDV | Unexpected Data Value |
| USI | User Service Information |
| WAP | Wireless Access Protocol |

Technical references, the entirety of each of which is incorporated by reference herein:
GSM 902 on MAP specification
Digital cellular telecommunications system (Phase 2+)

### Mobile Application Part (MAP) Specification

(3GPP TS 09.02 version 7.9.0 Release 1998)

### GSM 340 on SMS

Digital cellular telecommunications system (Phase 2+)
Technical realization of the Short Message Service (SMS)
(GSM 03.40 version 7.4.0 Release 1998)

### GSM 378 on CAMEL,

### GSM 978 on CAMEL Application Protocol,

### GSM 379 on CAMEL Support of Optimal Routing (SOR),

### GSM 318 on CAMEL Basic Call Handling

ITU-T Recommendation Q.1214 (1995), Distributed functional plane for intelligent network CS-1,
ITU-T Recommendation Q.1218 (1995), Interface Recommendation for intelligent network CS-1,
ITU-T Recommendation Q.762 (1999), Signaling system No. 7—ISDN user part general functions of messages and signals,
ITU-T Recommendation Q.763 (1999), Signaling system No. 7—ISDN user part formats and codes,
ITU-T Recommendation Q.764 (1999), Signaling system No. 7—ISDN user part signaling procedures,
ITU-T Recommendation Q.765 (1998), Signaling system No. 7—Application transport mechanism,
ITU-T Recommendation Q.766 (1993), Performance objectives in the integrated services digital network application,
ITU-T Recommendation Q.769.1 (1999), Signaling system No. 7—ISDN user part enhancements for the support of Number Portability

What is claimed is:

1. A method for facilitating local data services for users, the method comprising:
detecting a location update message of a user at a gateway, the gateway being a communication exchange system having an ecosystem of one or more HPMN and VPMN operators;
enabling one or more of a real profile and a virtual profile in a user's device to enable local data services for the user, wherein the real profile and the virtual profile are from a partner operator within the ecosystem of the HPMN and VPMN operators, and wherein the user's device has one or more of a soft-SIM, a normal SIM, an embedded SIM, an interface, and a SIM applet.

2. The method of claim 1, wherein the user roams in the VPMN with one of a roaming relationship and a non-roaming relationship between the HPMN, VPMN and the partner operator.

3. The method of claim 1, wherein the detection of the location update message of the user at the gateway reveals information about the user's current country and current operator.

4. The method of claim 1, wherein the real profile or the virtual profile of the operator is enabled based on one or more of a location of the user, a class of the user, a quality of service from the partner operator, a coverage of the partner operator, and a tariff charged by the partner operator.

5. The method of claim 1, wherein the interface provides one or more of updates to the interface, end to end security between interface and the gateway, and firewall protection for the user's device.

6. The method of claim 1, wherein enabling of the real profile of the partner operator further comprises:
allocating a dynamic IMSI with either a partial IMSI profile or a full IMSI profile based on the user's device; wherein a full profile has security key information of a HPMN or the VPMN; and
switching from an IMSI profile of the user's device to one of a HPMN IMSI profile or local IMSI profile of the partner operator, wherein the partner operator within the ecosystem is selected by a cloudSIM hub that acts as the gateway, depending on one or more of a location of the user's device, and quality and regulatory requirements of roaming service associated with the user's device.

7. The method of claim 6, wherein the cloudSIM hub uses SIM Toolkit Applet (STK Applet) in a standard SIM card along with OTA function to handle dynamic IMSI.

8. The method of claim 7, wherein dynamic IMSI allocation is performed by a cloudSIM DIA (Dynamic IMSI Allocation) platform.

9. The method of claim 7, wherein dynamic IMSI allocation works in one of a pull mode and a push mode.

10. The method of claim 9, wherein in the pull mode, the STK Applet provides the cloudSIM DIA information for subscriber location and device.

11. The method of claim 9, wherein in the push mode, cloudSIM DIA gets subscriber's location and device information via a roaming probe.

12. The method of claim 7, wherein dynamic IMSI allocation includes allocating one of a local IMSI, a permanent roaming IMSI, and a temporary roaming IMSI.

13. The method of claim 7, wherein selection of hub operator is based on one or more criteria including a wholesale tariff agreed in visited country, a type of subscriber, devices being services, a pre-paid or a postpaid plan, a full service or a data service, and a cost or a QoS ranking of network in visited country.

14. The method of claim 7, wherein dynamic IMSI allocation is performed using the STK applet to detect and notify IMEI of device for OMACP based devices.

15. A system for facilitating local data service for users, the system comprising:
an ecosystem of one or more HPMN and VPMN operators;
a gateway that detects a location update message of a user and enables one or more of a real profile and a virtual profile from a partner operator to facilitate local data services in a user's device, wherein the user's device has one or more of a soft-SIM, normal SIM, an embedded SIM, an interface, and a SIM applet.

16. The system of claim 15, wherein the user roams in the VPMN with one of a roaming relationship and a non-roaming relationship between the HPMN, VPMN, and the partner operator.

17. The system of claim 15, wherein the location update message of the user at the gateway reveals information about the user's current country and current operator.

18. The system of claim 15, wherein the gateway enables the real profile or the virtual profile of the operator based on one or more of a location of the user, a class of the user, a quality of service from the partner operator, a coverage of the partner operator, and a tariff charged by the partner operator.

19. The system of claim 15, wherein the interface provides one or more of updates to the interface, end to end security between the interface and the gateway, and firewall protection for the user's device.

20. The system of claim 15, wherein the gateway enables the real profile of the partner operator by:
allocating a dynamic IMSI with either a partial IMSI profile or a full IMSI profile based on the user's device; with a full profile that has security key information of a HPMN or the VPMN; and
switching from the user's device's IMSI profile to one of a HPMN IMSI profile or local IMSI profile of the partner operator, wherein the partner operator within the ecosystem is selected by a cloudSIM hub that acts as the gateway, depending on one or more of location of the user's device, and quality and regulatory requirements of roaming service associated with the user's device.
